(19) United States
(12) Patent Application Publication
(10) Pub. No.: US 2026/0327948 A1
(43) Pub. Date: Oct. 22, 2026

(54) DECOUPLED VEHICLE CONTROL SYSTEM

(71) Applicant: Bedrock Robotics Inc., San Francisco, CA (US)

(72) Inventors: Matthieu Guilbert, San Francisco, CA (US); Boris Sofman, San Francisco, CA (US); Ajay Gummalla, San Francisco, CA (US)

(73) Assignee: Bedrock Robotics Inc., San Francisco, CA (US)

(21) Appl. No.: 19/726,282

(22) Filed: Jun. 30, 2026

Related U.S. Application Data
(63) Continuation-in-part of application No. 19/637,998, filed on Apr. 2, 2026.
(60) Provisional application No. 63/783,119, filed on Apr. 3, 2025.
(60) Provisional application No. 63/837,364, filed on Jul. 2, 2025.

(51) Int. Cl. E02F 9/24; E02F 9/26; G06N 3/02

(52) U.S. Cl. CPC E02F 9/24; E02F 9/265; E02F 9/268; G06N 3/02

(57) ABSTRACT

In variants, the method can include: sampling a set of sensor measurements; determining a world representation from the set of sensor measurements; determining a set of buffer volumes; determining position set volumes based on a set of control instructions; evaluating collisions between the position set volume and the set of buffer volumes; and determining a set of final control instructions based on the collision evaluation.

### CROSS-REFERENCE TO RELATED APPLICATIONS

This application is a continuation in part of US Application Number 19/637,998 filed Apr. 2, 2026, which claims the benefit of US Provisional Application number 63/783,119 filed Apr. 3, 2025, each of which is incorporated in its entirety by this reference.

This application claims the benefit of US Provisional Application number 63/837,364 filed Jul 2, 2025, which is incorporated in its entirety by this reference.

### TECHNICAL FIELD

This invention relates generally to the autonomous vehicle field, and more specifically to a new and useful decoupled safety system in the autonomous vehicle field.

### BRIEF DESCRIPTION OF THE DRAWINGS

FIG. 1 is a schematic representation of a variant of the system.

FIG. 2 is a schematic representation of an example of the system.

FIG. 3 is a schematic representation of a variant of the system processing split.

FIG. 4 is a schematic representation of a variant of the method.

FIG. 5 is an illustrative example of a vehicle that the system and method can be used with.

FIG. 6 is an illustrative example of data flow through an example of the system.

FIG. 7 is a second illustrative example of data flow through an example of the system.

FIG. 8 is an illustrative example of a variant of the set of buffer volumes.

FIG. 9 is an illustrative example of a variant of the set of nested buffer volumes.

FIG. 10 is an illustrative example of the nested buffer volumes with different permitted action sets.

FIG. 11 is an illustrative example of the set of actuator trajectory buffer volumes.

FIG. 12 is a schematic representation of a variant of the safety method.

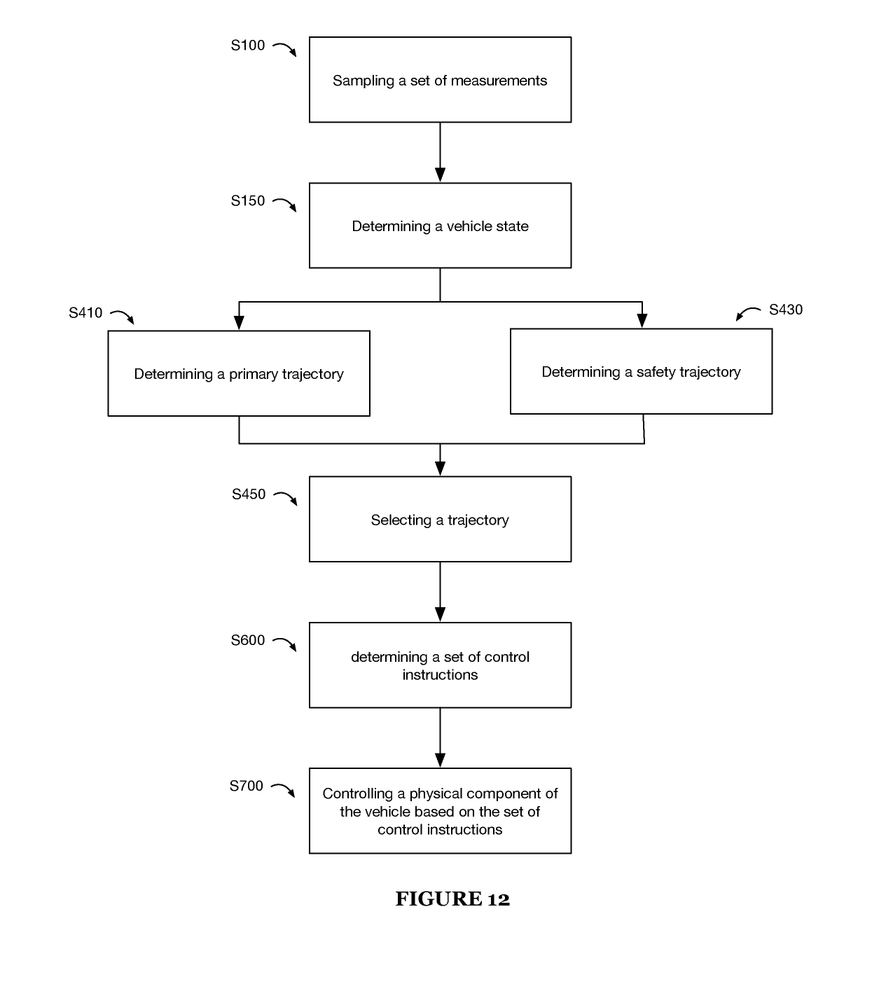

FIG. 13 is a schematic representation of an example of the safety method.

FIG. 14 is a schematic representation of an example of the safety system.

### DETAILED DESCRIPTION OF THE INVENTION

The following description of the embodiments of the invention is not intended to limit the invention to these embodiments, but rather to enable any person skilled in the art to make and use this invention.

1. Overview

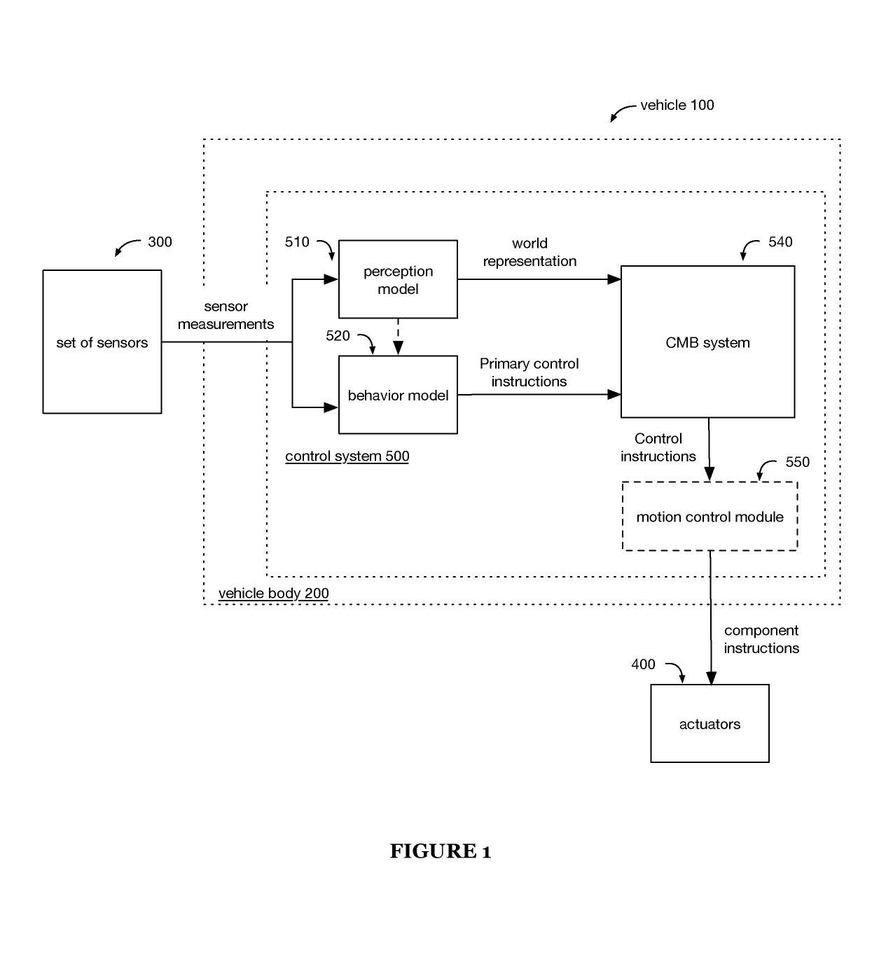

As shown in FIG. 1, in variants, the system can include: a vehicle 100; a control system 500; and a processing system 600. The system functions to provide an autonomous vehicle control system with a deterministic, physics-based safety system that is separate from the behavior model.

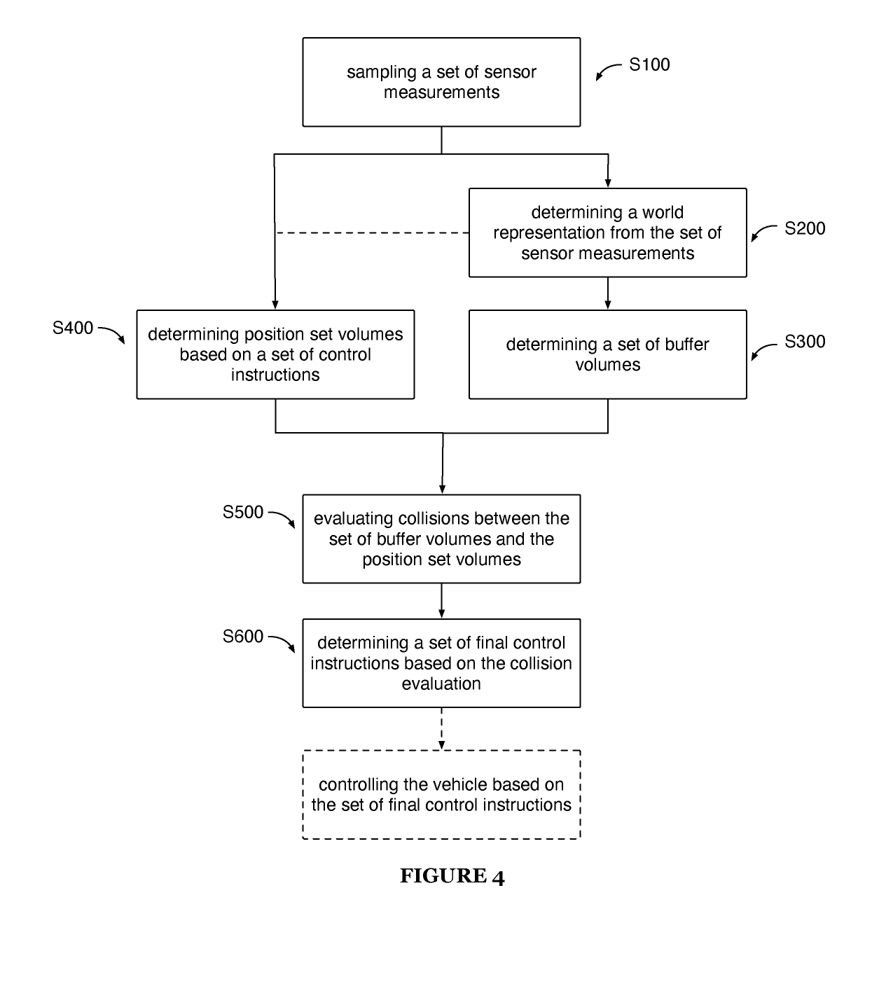

As shown in FIG. 4, variants of the method can include: sampling a set of sensor measurements S100; determining a world representation from the set of sensor measurements S200; determining a set of buffer volumes S300; determining position set volumes based on a set of control instructions S400; evaluating collisions between the position set volume and the set of buffer volumes S500; and determining a set of final control instructions based on the collision evaluation S600. The method functions to enforce compliant (e.g., collision-free, safe, etc.) vehicle operation.

In an illustrative example, a control system for an autonomous vehicle can include: a perception system configured to detect objects in the environment; a set of behavior models configured to determine primary control instructions (e.g., vehicle trajectories, construction actuator trajectories) based on the detected objects; a collision mitigation braking (CMB) system, separate and distinct from the set of behavior models, that is configured to determine buffer volumes around the set of detected objects and ego vehicle components and evaluate whether a future collision will occur by evaluating whether a swept volume of the f associated with the primary control instructions (e.g., vehicle trajectory, construction actuator trajectory, etc.) intersects the buffer volumes of the external objects or ego vehicle components (e.g., whether the vehicle will collide with an external object or itself), and controlling the vehicle to stop (e.g., emergency stop, gradual stop, etc.) when a future collision is detected. In a specific example, the CMB system can determine a set of fallback control instructions (e.g., fallback trajectories, stable stopping instructions, etc.), wherein the fallback control instructions are used in lieu of the primary control instructions when a collision is detected (e.g., by selecting the fallback control instructions, by not passing the primary control instructions, etc.).

The primary control instructions can impose a hard constraint, a soft constraint, a constraint with a satisfaction time window, and/or be otherwise configured. In a specific example, the set of buffer volumes can be dynamically determined based on the ego vehicle component and/or object's predicted kinematics (e.g., trajectory, velocity, acceleration, etc.), class (e.g., 6ft safety units for humans, 1 in safety units for dump truck beds), and/or other object parameter, or be predetermined. Buffer volumes can be defined for different parts of the ego vehicle (e.g., end effector vs. body vs. drive actuators), which can provide safety checks for self-intersections. In a specific example, the collision evaluation can be performed as a set of intersection checks between each of the plurality of safety units and the position set's collective volume (e.g., swept volume). In another example, the safety system can detect ego vehicle component intersection (e.g., current or future) with exclusionary regions defined in the environment (e.g., tip-over risk regions, geofenced blocked zones, etc.), wherein the exclusionary regions can be computed based on the ego vehicle dynamics, vehicle pose, vehicle direction of motion, and/or other parameters, and halt vehicle operation before crossover into the exclusionary region.

In variants, the system can be implemented on split hardware, with the perception system, behavior models, and collision mitigation braking (CMB) system executed on non-safety-qualified compute (e.g., a GPU, TPU, IPU, etc.), while a motion controller (e.g., configured to generate ego vehicle component instructions based on the control instructions) can be executed on safety-qualified compute (e.g., a CPU, FPGA, microprocessor, etc.).

However, the system and/or method can be otherwise performed.

2. Technical advantages

Variants of the technology can confer one or more advantages over conventional technologies.

First, variants of the technology can enable rapid behavior model iteration and deployment and/or use of stochastic behavior models in safety-critical autonomous vehicle applications through the decoupling of safety and behavior systems. By separating these traditionally intertwined systems, behavioral algorithms (e.g., path planning, navigation strategies, etc.) can be dynamically modified and updated without requiring extensive re-validation of safety mechanisms. For example, new driving behaviors or routing algorithms can be deployed while maintaining existing safety guarantees. This architectural approach can reduce development cycles and accelerate the deployment of autonomous vehicle software updates. This can be further reinforced by executing stochastic, variable, and/or high-compute processes (e.g., perception model execution, behavior model execution, CMB system execution, etc.) on non-safety-qualified compute, while executing deterministic processes (e.g., the motion controller, control instruction transformation into component instructions, emergency execution of the fallback control instructions, etc.) on safety-qualified compute.

Second, variants of the technology can provide deterministic and mathematically provable behavior and/or control safety guarantees through the implementation of simplified, physics-based collision detection using geometric primitives. For example, the use of spherical primitives (e.g., safety units) positioned along object geometries and ego vehicle components can enable efficient distance calculations and overlap detection between objects, which allows the system to perform rapid collision checks with well-defined mathematical properties. This approach can facilitate formal verification of safety properties, which can be challenging with conventional probabilistic methods.

Third, variants of the technology can achieve fast (e.g., sub-200 millisecond, sub-500 millisecond, sub-second, on the order of the actuator reaction time, etc.) reaction times from initial object detection to brake activation through computationally efficient buffer volume calculations. The use of simplified geometric representations can reduce the computational overhead typically associated with complex object modeling and position set (e.g., trajectory) prediction. For example, the system can rapidly compute potential collision zones using basic geometric operations on safety primitives, enabling fast emergency response actions. This speed of computation can be particularly beneficial in scenarios requiring immediate defensive maneuvers.

Fourth, variants of the technology can reduce system complexity compared to statistical behavior and/or control safety approaches by treating detected objects as static entities and employing adjustable buffer volumes rather than behavior prediction models. This approach can eliminate the computational burden of probabilistic trajectory forecasting and uncertainty propagation. For example, by dynamically adjusting buffer volume sizes based on object characteristics (e.g., speed, size, type), the system can maintain conservative safety margins without the need for complex behavioral modeling. This simplification can lead to more robust and predictable system performance. Furthermore, this simplification can enable the safety system to be generalizable to different machine types (e.g., by adjusting the physical parameters modeling the ego vehicle, etc.), even when the vehicle form, function, or behavior differs.

Fifth, variants of the technology can enable the system to detect and avoid sudden hazards (e.g., hazards that were not foreseen, mitigated against, or predicted during planning). For example, because the CMB system can run at a higher frequency than the planner and uses more up-to-date sensor measurements, the CMB can detect debris collisions or falling rocks from the vehicle's bucket that were not foreseen during planning, and immediately mitigate the detected hazard (e.g., by halting the vehicle bucket, by alerting the user, actuating construction actuators, etc.).

Sixth, variants of the technology provide a safety wrapper around any vehicle actuator inputs. The vehicle actuator inputs can be: predicted by a behavior module, received from a user (e.g., an in-cab user, a teleoperator, etc.), and/or otherwise determined.

However, further advantages can be provided by the system and method disclosed herein.

3. System

In variants, the system can include: a vehicle 100; a control system 500; and a processing system 600. The system functions to provide an autonomous vehicle control system with a deterministic, physics-based safety system that is separate from the behavior model. This can enable the system to provide vehicle safety, independent of the behavior model's capabilities.

The vehicle 100 functions to receive and/or execute component instructions representing control instructions. The vehicle 100 is preferably an autonomous vehicle (e.g., level 2, level 3, level 4, level 5, etc.), but can alternatively be a semi-autonomous vehicle, a vehicle with driver assistance features, and/or otherwise automated or not automated. The vehicle 100 is preferably a construction vehicle (e.g., excavators, bulldozers, wheel loaders, dump trucks, cranes, compactors, tractors, mine trucks, lumber machines, bulldozers, etc.), but can alternatively be an agricultural vehicle (e.g., a tractor, a combine harvester, etc.), road vehicle (e.g., passenger vehicles, delivery vehicles, etc.), and/or any other type of machine or vehicle. The vehicle 100 is preferably an electric vehicle, but can alternatively be a hybrid vehicle, internal combustion engine vehicle, and/or any other vehicle.

In variants, the vehicle 100 includes a vehicle body 200; a set of sensors 300; actuators 400; and/or other components.

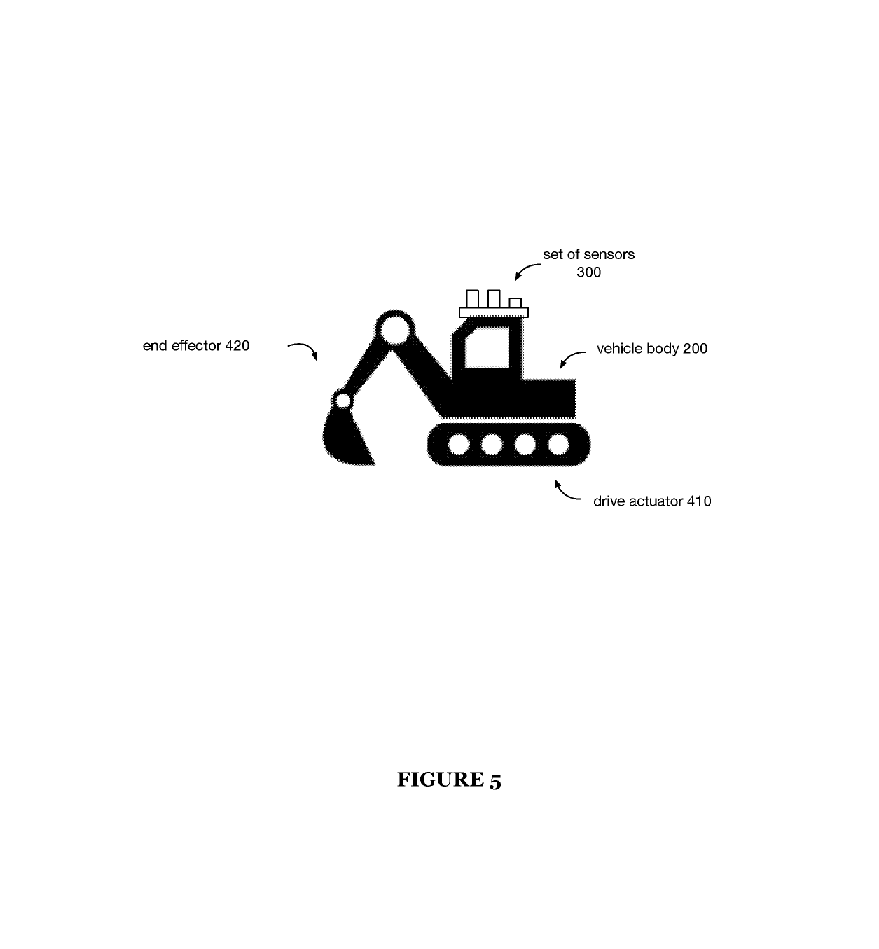

The vehicle body 200 can include a cab, a mounting point for sensors and onboard processing (e.g., the control system), and/or any other components. An example of the vehicle body 200 is shown in FIG. 5. However, the vehicle body 200 may be otherwise configured.

The set of sensors 300 functions to sample measurements of the physical environment adjacent the vehicle. The set of sensors 300 is preferably mounted to the vehicle body, but can alternatively be mounted to the actuators, detached from the vehicle, and/or any other vehicle component. Examples of sensors that can be used include: Lidar sensors, radar sensors (e.g., ground penetrating radar, doppler radar, passive radar, etc.), ultrasonic sensors, infrared cameras, stereoscopic cameras, thermal imaging sensors, proximity sensors, time-of-flight cameras, inertial measurement units (IMUs), global positioning system (GPS) receivers, wheel encoders for position tracking, acoustic sensors (e.g., transducers, microphones, speakers, etc.), loop sensors, and/or any other sensors. The field of view of the set of sensors 300 can include 1 to 360 degrees around the vehicle, 0 to 360 degrees above or below the midline of the vehicle, the actuators, the volume around the actuators, the ego vehicle, and/or cover any other region around the vehicle. The set of sensors 300 can be in communication with the control system, a local processing system, a remote processing system, and/or any other processing system. However, the set of sensors 300 may be otherwise configured.

The actuators 400 function to interact with the physical environment adjacent the vehicle. The actuators 400 are preferably controlled based on control instructions generated by the control system but can alternatively be otherwise controlled. The actuators 400 can be actuatably mounted to the vehicle body (e.g., move relative to the vehicle body), but can alternatively be otherwise attached to the vehicle.

The actuators 400 can include drive actuators 410; end effectors 420; and/or other actuators.

The drive actuators 410 function to move the vehicle body through the environment and can include drivetrains, motors, power transfer elements and/or any other drive actuators. The rotary axis of the drive actuators are preferably statically mounted to the vehicle body (e.g., the tread drive shafts or wheel axles are statically retainers relative to the vehicle body), but can alternatively move relative to the body.

The end effectors 420 function to manipulate the physical environment adjacent the vehicle. The actuators 400 can include excavator arms, boom-and-stick assemblies, bucket assemblies, blades, lifting arms, cargo bed, crane booms, pump outriggers, shovel dippers, material conveyor systems, and/or any other suitable end effector (e.g., construction actuator, manipulator, articulated component, etc.). The end effectors 420 are preferably actuatable relative to the vehicle body (e.g., connected to the vehicle body by a set of links and joints, etc.), but can alternatively be static relative to the vehicle body. In an example, the end effectors' range of motion can cause self-collisions with the rest of the vehicle (e.g., another actuator, the vehicle body, and/or any other component). In an example, the end effectors can be an articulated component kinematically downstream of a controllable joint. The end effectors 420 can be multi-jointed or have a single joint, and can have complex degrees of freedom (e.g., more than 2DOF, 3 DOF, 4 DOF, 5 DOF, 6 DOF, etc.).

However, the actuators 400 may be otherwise configured.

However, the vehicle 100 may be otherwise configured.

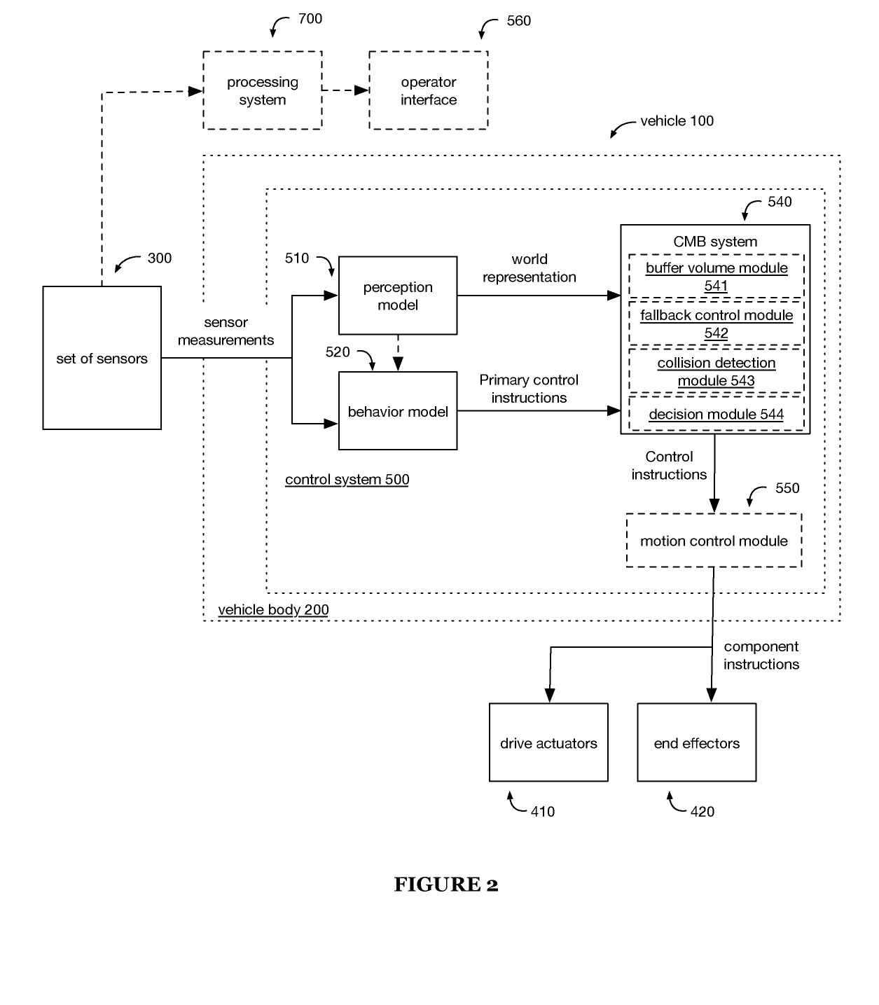

The control system 500 functions to determine control instructions for the vehicle based on the measurements. All or portions of the control system 500 are preferably onboard the vehicle (e.g., mounted to the vehicle body), but can alternatively be remote from the vehicle. An example of the control system 500 is shown in FIG. 2. All or portions of the control system 500 can be executed on the main compute, the safety compute, a remote computing system, and/or any other processing system.

In a first variant, the perception models, behavior models, and safety systems (e.g., CMB system) are executed on the main compute, while the motion control module (e.g., motion controller) is executed on the safety compute.

In a second variant, the perception models and behavior models are executed on the main compute, while the safety systems (e.g., CMB system) and motion control modules (e.g., motion controller) are executed on the safety compute.

In a third variant, stochastic or computationally intensive models (e.g., perception models, behavior models, fallback control instruction module of the CMB system, and/or any other models) are executed on the main compute, while deterministic or low-compute models (e.g., the motion controller) are executed on the safety compute.

In a fourth variant, the entire control system 500 can be wholly executed on the main compute and/or safety compute.

The control system 500 can additionally and/or alternatively be otherwise distributed across different computing systems.

In variants, the control system 500 can include one or more: perception models 510; behavior models 520; an optional stability module 530; a collision mitigation braking (CMB) system 540; a motion control module 550; an optional operator interface 560; and/or any other module. However, the control system can optionally include: a driver (e.g., in-cab driver), a teleoperator, and/or any other suitable control instruction input. The control instructions can be directly commanded, computed from a motion model of commands, and/or otherwise determined.

A perception model 510 functions to generate a world representation of the environment based on the measurements sampled by the set of sensors. The perception models 510 can receive measurements from onboard sensors, sensors mounted to the environment, sensors from other vehicles, and/or any other measurements. The world representation can include: a map (e.g., depth map, BEV map, distance map, etc.), frame (e.g., a reference coordinate system, relative pose, etc.), set of object detections, set of object segments (e.g., 2D mask boundaries, instance segments, semantic labels, etc.), set of object tracks (e.g., including temporarily occluded objects), a set of exclusion regions (e.g., geofences), a set of permitted regions, shape representations (e.g., point clouds, 3D meshes, convex hulls, bounding volumes, etc.), relational or topological representations, and/or any other representations. The set of object detections can be associated with: the object type (e.g., labels), predicted object kinematics (e.g., acceleration, velocity, trajectory, etc.), object kinematics, predicted goals (e.g., predicted based on the object class, historical trajectory, etc.), object boundaries, bounding boxes, object pose (e.g., position, orientation, etc.; relative to a global reference, relative to the ego vehicle, etc.),

object state, and/or any other associations. In an example, the world representation can include elements associated with the ego vehicle, objects in the scene (e.g., other machines and/or vehicles, people, etc.), terrain (e.g., slopes, hazards, ground textures, water, etc.), utilities, and/or any other elements. The world representation can be provided to: the collision mitigation braking (CMB) system (e.g., for buffer volume determination), the behavior model (e.g., for control instruction determination), the motion controller (e.g., for component instruction determination), the stability system (e.g., for stable trajectory generation, for terrain-based stability estimations, etc.), and/or any other model. The world representation can optionally be: sent to a remote computing system (e.g., for telemetry, for site analyses, etc.), cached and used when a world representation for a future timestep cannot be determined (e.g., has lower than a threshold confidence level), and/or otherwise used. The world representation is preferably generated for each control timestep, but can alternatively be generated at a predetermined frequency (e.g., every 2-60 seconds), when a trigger event occurs (e.g., when an actual detection deviates beyond a threshold from an expected detection), and/or at any other time. The world representation can be: wholly regenerated, updated (e.g., partially updated), and/or otherwise generated. The perception models 510 can include object detectors, tracking models (e.g., object tracking, motion prediction, trajectory estimation, etc.), segmentation models (e.g., semantic segmentation models, instance-based segmentation models), mapping modules, hull generation models, clustering models, signed distance function evaluators, DNNs, CNNs, RNNs, transformers, GNNs, VAEs, diffusion models, RL policy models, and/or any other models.

In a variant, the perception models 510 can include multi-sensor fusion, multi-view fusion, temporal fusion, and/or any other fusion. In an example, the perception models 510 can fuse sensor modalities (e.g., LiDAR and camera data, radar and IMU data, and/or any other sensor modalities) to generate the world representation. The perception models 510 are preferably not certified (e.g., not safety-qualified), but can alternatively be certified.

However, the perception models 510 may be otherwise configured.

The behavior models 520 function to generate primary control instructions. The primary control instructions can be generated based on the measurements (e.g., sampled by the sensor set), the world representation, and/or any other basis. The primary control instructions are preferably position sets (e.g., trajectories; a set of vehicle component positions within the environment), but can alternatively be low-level actuator instructions (e.g., target x/y/z/rotation, applied voltage, applied current, low-level actuator driver calls, etc.), waypoints, latent behavior codes, distributions over trajectories, and/or any other control instructions. The position set can include: a single position, a series of positions (e.g., trajectory), a distribution of possible positions (e.g., given the current end effector configuration), and/or any number of positions. The position set can be for: the construction actuator, drive actuator, vehicle body, a combination thereof (e.g., a combination of arm, body, multiple end effectors, etc.), and/or any other suitable vehicle component. A trajectory can include an ordered sequence of positions, orientations, velocities, accelerations, and/or any other ordered sequence parameters. The trajectories can be parameterized over time, include a sequence of states, and/or any other trajectory characteristics. The position sets can be limited by constraints associated with a vehicle and/or end effector (e.g., kinematic, dynamic, etc.).

In a first example, a behavior model can generate primary control instructions based on speed, acceleration, and/or jerk limits of end effectors.

In a second example, a behavior model can exclude primary control instructions which require impossible steering (e.g., requiring a smaller turn radius than possible, non-holonomic steering, instantaneous rotation etc.).

In a third example, a behavior can use known joint relationships and/or linkages to reduce the possible trajectory space however, the trajectories can be otherwise configured.

The primary control instructions can include vehicle trajectories (e.g., used to determine actuator instructions for the drive actuators, to move the vehicle within the environment), end effector trajectories (e.g., used to determine actuator instructions for the construction actuators, to move the end effectors relative to the vehicle and/or environment), and/or trajectories for any other vehicle component. Additionally or alternatively, the primary control instructions can be generated by a human operator (e.g., in-cabin), a teleoperator, and/or any other control instruction source.

The primary control instructions can be used to determine trajectory collisions (e.g., between the vehicle and an object in the environment, between vehicle components, etc.), determine actuator control instructions (e.g., joint control instructions, motor instructions, etc.), and/or otherwise used.

The behavior models 520 preferably predict the primary control instructions, but can alternatively compute, select (e.g., from a set of predefined trajectories), and/or otherwise determine the primary control instructions. The behavior models 520 can generate a single candidate trajectory, multiple candidate trajectories, and/or any other candidate trajectories. The behavior models 520 can generate multiple candidate trajectories in parallel or in series.

In a first variant, candidate trajectories can be successively generated when the respective trajectory confidence score falls below a threshold.

In a second variant, the behavior model can include a plurality of models, wherein each model generates a different candidate trajectory.

The behavior models 520 can generate the primary control instructions for: each planning timestep, every control timestep, at a predetermined frequency, (e.g., every 10-100 milliseconds, every 20-50 milliseconds, etc.), in response to an insufficient control instruction (e.g., detected collision, low confidence score, low predicted safety score, etc.), and/or at any other time. The control system can include one or more behavior models 520 of the same or different type. Different behavior models 520 can have different model architectures, different training methods, be trained on different datasets, output different output types, and/or otherwise differ. The behavior models 520 can be specific to: the type of vehicle (e.g., excavator behavior model, bulldozer behavior model, etc.), the make and model of the vehicle (e.g., Caterpillar 336 hydraulic excavator behavior model, Caterpillar 320 GC excavator behavior model, etc.), the construction actuator type (e.g., arm behavior model, boom behavior model, etc.), the overall task or construction goal (e.g., lane construction behavior model, excavation behavior model, etc.), configuration specific, be a generic behavior model, and/or be otherwise generic or specific.

A behavior model can include: a machine learning model (e.g., DNNs, transformers, diffusion models, CNNs, autoencoders, MLP, mixture density networks (MDNs), RNNs, variational autoencoders (VAEs), GNNs, energy-based models, policy networks, hierarchical policies, etc.), but can alternatively be a rule set, a classical model (e.g., kinematic model, dynamic model, LQR, model predictive control (MPC) model, etc.), and/or any other model.

The behavior models 520 are preferably not certified (e.g., not safety-qualified) but can alternatively be certified. The behavior models 520 can be a separate model from the perception model, share layers with the perception model, be part of the same model as the perception model, and/or be otherwise related to the perception model. In an example, the behavior models 520 can share a set of embedding layers with the perception model but have a separate output head. The behavior models 520 are preferably probabilistic (e.g., statistically predicts the primary control instructions), but can alternatively be deterministic.

The behavior models 520 preferably exclude safety checks but can alternatively include safety checks. The behavior models 520 are preferably not trained to avoid collisions but can alternatively be trained to avoid collisions.

The behavior models 520 can be updated periodically, when a new behavior model version is available, when new training data is available, be trained online (e.g., during operation, after each operation session, etc.), and/or otherwise updated. The behavior models 520 can be updated using over-the-air updates, manually loaded, and/or otherwise updated. The behavior models 520 can be updated without recertification, with recertification, and/or otherwise updated.

However, the behavior models 520 may be otherwise configured.

The control system 500 can optionally include a stability module 530, which functions to evaluate whether the trajectory is stable.

In a first variant, the stability module 530 generates a set of stability buffer volumes, which can function to define exclusionary regions for the vehicle and/or construction actuator. These exclusionary regions can be defined to prevent the vehicle from tipping over and/or prevent the vehicle from entering high-risk regions (e.g., occluded regions), and can be used as part of the checked buffer volumes in S500. The stability buffer volumes can be computed from the current pose of the vehicle and the set of possible construction actuator positions, wherein the subset of construction actuator positions that result in a projection of the vehicle's center of gravity falling outside the vehicle's base of support (e.g., resulting in vehicle instability) can be identified. The stability buffer volumes are then defined around the identified subset of construction actuator positions. However, the stability buffer volumes can be otherwise determined.

In a second variant, the stability module 530 performs a set of center of mass checks at different points along the position set (e.g., estimates whether the anticipated center of mass will fall outside of the base of support at all or a subset of points in the position set), and uses a fallback control instruction when the center of mass check fails (e.g., the center of mass falls outside the base of support). The position set can include the position set generated by the behavior model, a fallback position set (e.g., a deceleration position set), and/or any other position set. The stability module 530 can include determining a mass of matter manipulated by an end effector (e.g., by estimating, using sensor measurements, load cell measurements, and/or any other measurements), generating the set of fallback control instructions based on the mass of matter manipulated by the end effector, and/or optionally evaluating whether the center of mass will fall outside the base of support of the construction vehicle.

However, the stability module 530 may be otherwise configured.

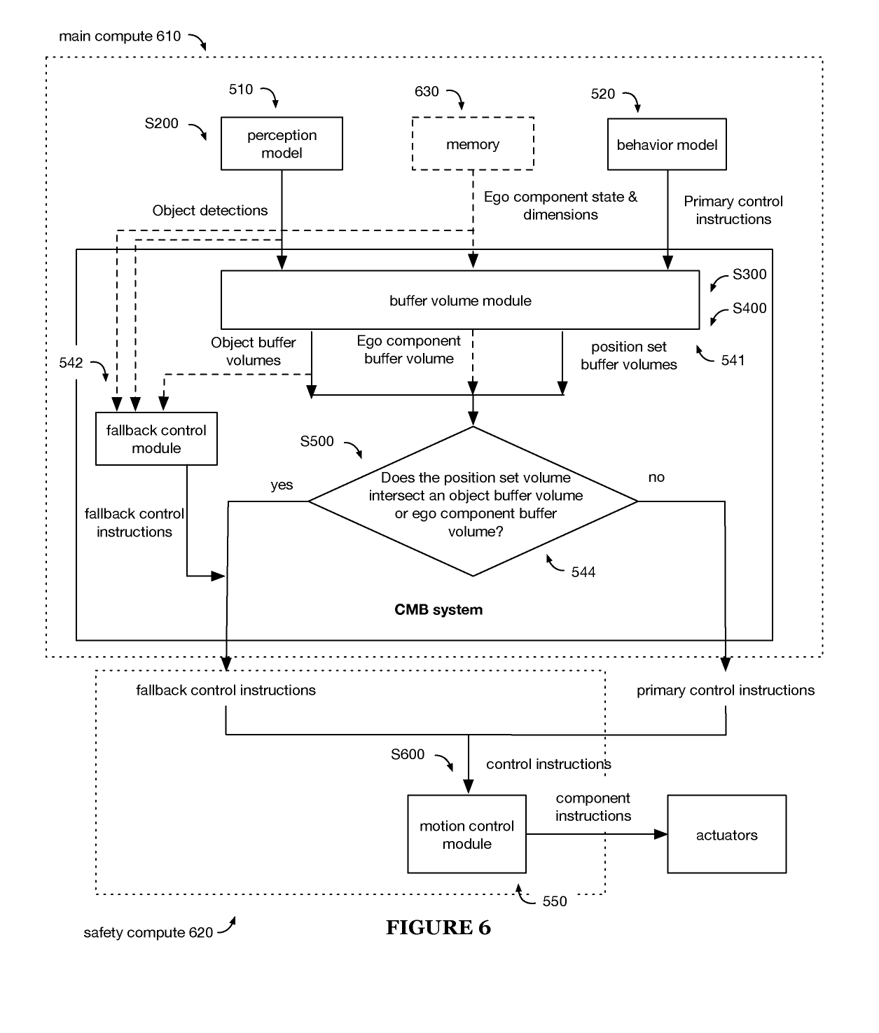

The collision mitigation braking (CMB) system 540 functions to rapidly evaluate the safety of the primary control instructions by determining whether the vehicle's position set (e.g., current vehicle position, the set of vehicle component positions resulting from the control instructions) will collide with objects (e.g., external objects, ego vehicle components, etc.). An example of the collision mitigation braking (CMB) system 540 is shown in FIG. 6.

The vehicle position set can be output by the behavior model, extrapolated from control inputs (e.g., driver inputs), and/or otherwise determined. The position set can include: positions along a predicted position set (e.g., trajectory; positions along a distribution of position sets (e.g., distribution of trajectories; constrained by a set of feasible motions given the current vehicle component pose); and/or any other suitable set of positions.

In an example, the CMB can: determine a set of buffer volumes; determine a position set volume based on a set of control instructions; evaluate collisions between the trajectory volume and the set of buffer volumes; determine a set of final control instructions based on the collision evaluation; and/or perform any other function.

In an example, the collision mitigation braking (CMB) system 540 can determine whether the trajectory (optionally expanded by a trajectory margin) intersects the buffer volume around a set of objects. In a first specific example, the CMB can determine whether an end effector's trajectory volume will intersect the buffer volume around a set of objects. In a second specific example, the CMB system can determine swept volumes for the ego vehicle component and a secondary element (e.g., second ego vehicle component, detected object, and/or any other element) along their respective trajectories, and determine whether the swept volumes intersect. The swept volumes can be the swept volume of a geometric primitive (e.g., sphere, prism, and/or any other base geometry), a convex hull of the component or element, and/or other base geometry. In a third specific example, the CMB system can dynamically determine safety primitives (e.g., spheres, prisms, and/or any other safety primitive) around the ego vehicle component and a secondary element based on the respective predicted operational contexts, and determine whether the safety primitives intersect (e.g., overlap).

In a second example, the collision mitigation braking (CMB) system 540 can determine whether an object's buffer volume trajectory will intersect the end effector's safety volume.

In a third example, the collision mitigation braking (CMB) system 540 can determine whether an object's buffer volume intersects the end effector's safety volume.

The collision mitigation braking (CMB) system 540 can determine any other position set - safety volume intersection.

The collision mitigation braking (CMB) system 540 is preferably deterministic, but can additionally and/or alternatively be otherwise configured. The CMB system preferably does not use neural network based methods, but can alternatively use neural network based methods. In an example, physics-based methods compute buffer volumes by explicitly modeling system dynamics, constraints, and environmental interactions using mathematical equations and physical laws, while neural network methods learn safety bubble boundaries directly from training data without requiring explicit physical models. The physics approach provides interpretable results with guaranteed properties but may be computationally intensive, whereas neural networks can rapidly generate safety buffers after training but operate as black boxes with limited formal guarantees of their output boundaries.

The collision mitigation braking (CMB) system 540 is preferably separate from the behavior model but can alternatively be part of the behavior model. The collision mitigation braking (CMB) system 540 can be certified or not certified. The collision mitigation braking (CMB) system 540 can be certified independent of the behavior model and/or perception model or be certified with the remainder of the control system.

The same collision mitigation braking (CMB) system 540 can be used with one or more different behavior models. The collision mitigation braking (CMB) system 540 can be run at a higher frequency than the behavior model but can alternatively be run at the same or lower frequency. The collision mitigation braking (CMB) system 540 can be run one or more times during every control timestep (e.g., every 50 milliseconds, 100 milliseconds, 200 milliseconds, 500 milliseconds, 1 second, etc.), when a trigger condition is satisfied (e.g., the trajectory confidence falls below a threshold, the object detection confidence falls below a threshold, etc.), and/or at any other suitable time. The collision mitigation braking (CMB) system 540 can be run every control timestep, every N control timesteps, and/or for any set of control timesteps.

The collision mitigation braking (CMB) system 540 can evaluate the primary control instructions against the same world representation used to generate the primary control instructions, or against a different world representation. In an example, the collision mitigation braking (CMB) system 540 can evaluate the primary control instructions against real-time, up-to-date, and/or subsequent world representations, generated from sensor measurements sampled after those used to generate the primary control instructions.

In a first variant, the collision mitigation braking (CMB) system 540 evaluates the primary control instructions against buffer volumes generated from a world representation generated by the perception model, wherein the primary control instructions are generated from sensor measurements used to generate the world representation, but is not itself generated from the world representation.

In a second variant, the collision mitigation braking (CMB) system 540 evaluates the primary control instructions against buffer volumes generated from a world representation generated by the perception model, wherein the primary control instructions are generated the world representation.

In a third variant, the collision mitigation braking (CMB) system 540 evaluates the primary control instructions against buffer volumes generated from a world representation generated by the behavior model alongside the primary control instructions.

The collision mitigation braking (CMB) system 540 can alternatively evaluate the primary control instructions against buffer volumes generated from any other reference.

The collision mitigation braking (CMB) system 540 can evaluate the primary control instructions for future control timesteps (e.g., the next control timestep, the next N control timesteps, a predetermined future time window, N seconds out, etc.), the current control timestep (e.g., the primary control instructions currently being executed), and/or for any other control timestep.

The collision mitigation braking (CMB) system 540 is preferably executed on the main compute, but can alternatively be executed on the safety compute.

In a specific example, the perception model can generate a world representation based on sensor measurements, send the world representation to the CMB system, and optionally send the world representation to the behavior model; the behavior model can generate primary control instructions based on the sensor measurements and/or world representation; the behavior model can send the primary control instructions to the CMB system; and the CMB system can determine buffer volume sets for the ego vehicle components and detected objects, determine whether a collision will occur between the buffer volume sets, and send the primary control instructions to the motion control module when no collision is detected. In this specific example, the CMB system can additionally determine a set of fallback control instructions based on the world representation, and send the fallback control instructions to the motion control module (e.g., by default or conditionally, such as when the primary control instructions result in a collision).

In a first variant, the CMB system functions as a filter for the primary control instructions, wherein the CMB passes through the primary control instructions to the actuators (e.g., a drive by wire system) when the primary control instructions are safe, and sends the fallback control instructions to the actuators when the primary control instructions are not safe.

In a second variant, the CMB system generates the fallback control instructions as a secondary control signal, wherein a downstream component (e.g., filter, the machine, etc.) prioritizes primary control instruction execution and falls back to fallback control instruction execution when primary control instructions are unavailable.

In a third variant, the CMB system generates the fallback control instructions as a secondary control signal, wherein a downstream component (e.g., filter, the machine, etc.) evaluates which signal to use.

In an example of the third variant, a drive-by-wire system prioritizes control signals received from the CMB system over control signals received from the behavior models, and preferentially executes the CMB-provided control signals. In an example of the third variant, the CMB system can generate the fallback control instructions in parallel with the primary control instructions. However, collisions can be otherwise detected by the collision mitigation braking (CMB) system 540.

The collision mitigation braking (CMB) system 540 can include one or more CMB modules (e.g., buffer volume module, fallback control module, collision detection module, decision module, etc.), include one or more module configured to perform the functionalities of one or more of the modules discussed below, and/or otherwise compartmentalize the CMB functionalities. One or more of the CMB modules can be updated independently from the others (e.g., the CMB modules are modular); alternatively, the set of CMB modules can be updated together.

In variants, the collision mitigation braking (CMB) system 540 includes a buffer volume module 541; a fallback control module 542; a collision detection module 543; an optional decision module 544; and/or other modules.

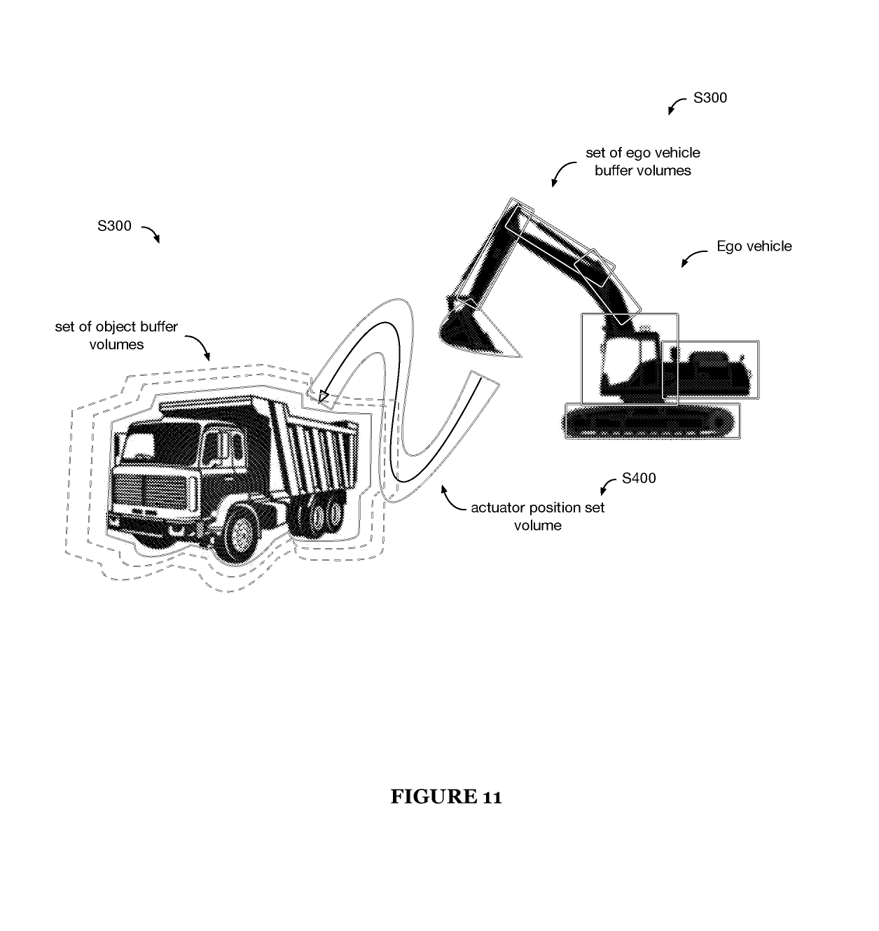

The buffer volume module 541 functions to determine a set of buffer volumes and/or position set buffer volumes. The buffer volume module 541 is preferably deterministic (e.g., geometry-based, rule-based, etc.), but can alternatively be stochastic or otherwise configured. The buffer volume module 541 is preferably a physics-based model (e.g., a rigid dynamic model, a set of equations, a set of physical laws, etc.), but can additionally or alternatively be a lookup model, geometric model, machine learning model, and/or any other model. The buffer volume module 541 can optionally include real-time estimation models, such as adaptive control laws (e.g., Slotin-lee methods, recursively squared methods, etc.), dynamic models, kinematic prediction models, and/or any other real-time estimation models, or not include real-time estimation models. The buffer volume module 541 can optionally include or receive data from a stability module (e.g., dyamics model that evaluates whether the center of mass of the object falls outside the support base), and/or any other model. The buffer volume module 541 can determine buffer volumes for: the ego vehicle, for different ego vehicle components (e.g., the cab, the end effector, etc.), external objects, the environment (e.g., terrain, no-go geofences, etc.), unstable regions, and/or any other regions. In an example, the buffer volume module 541 determines a different buffer volume for different ego vehicle components separated by joints (e.g., an example shown in FIG. 11). The buffer volume module 541 can determine a set of buffer volumes (e.g., nested buffer volumes, conditional buffer volumes, dynamic buffer volumes, etc.).

In a first variant, each object is associated with a single buffer volume.

In a second variant, each object is associated with a plurality of buffer volumes (e.g., as shown in FIG. 11). The volumes in the plurality can intersect, overlap, nest, and/or be otherwise configured. The volumes in the set can be associated with different permissions, actions, conditions, risk tolerances, and/or any other parameters.

In a first example of the second variant, the buffer volumes of the plurality can each cover a subset of the object surface, and collectively cover a majority (e.g., entirety) of the object.

In a second example of the second variant, the buffer volumes of the plurality can be nested, wherein different risks or errors are associated with each buffer volume (e.g., with lower risks or warnings associated with distal buffer volumes, and higher risks or warnings associated with proximal buffer volumes). In a specific example, a set of buffer volumes can include a first volume tracing an object associated with a default level of safety (e.g., do not impinge on the default margin), a second volume tracing a larger volume than the first volume associated with a condition (e.g., can impinge on the volume with an end effector, to load or unload matter, according to a schedule, etc.), a third volume associated with a section of the object (e.g., a larger buffer volume around the cab of a vehicle, a larger buffer volume where people are expected, etc.).

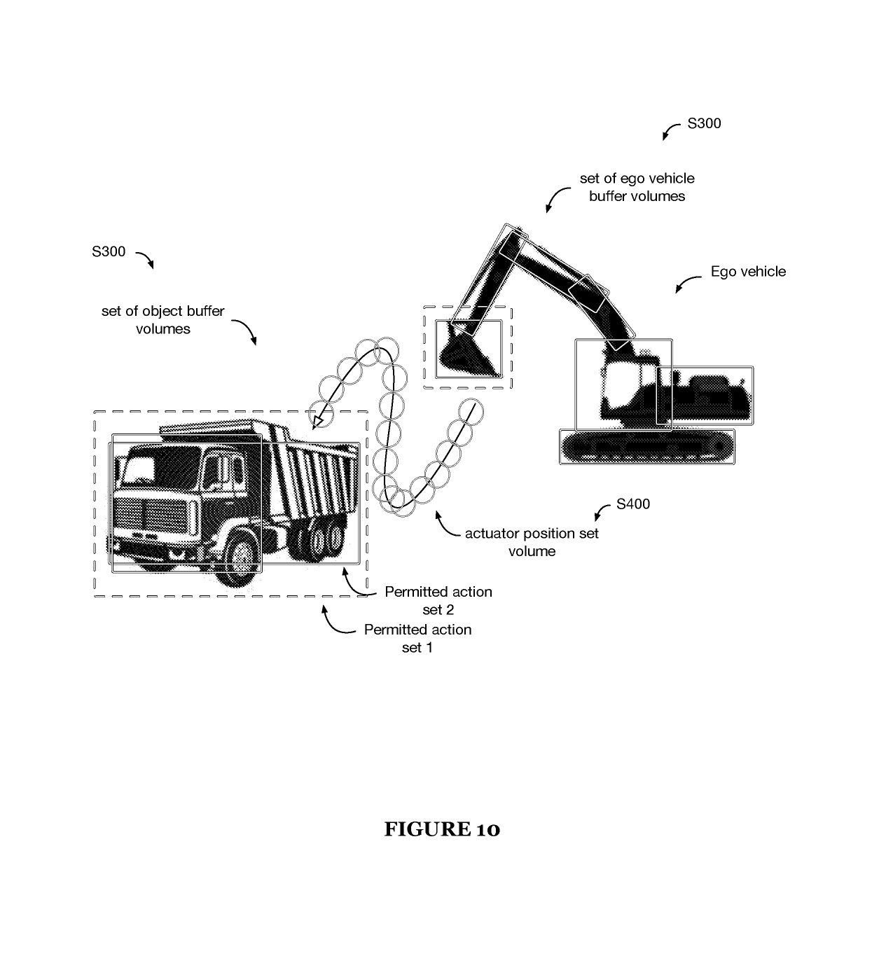

In a third example of the second variant, the buffer volumes of the plurality can be nested or overlap, wherein different actions are permitted in each buffer volume (e.g., as shown in FIG. 10). In a specific example of the third example, the nested buffer volumes can be associated with different permissions, including: ability for an end effector to touch an object; ability for an end effector to impinge on a first safety bubble, but not for a vehicle body to impinge on a first safety bubble; and/or any other permissions.

In a fourth example of the second variant, the buffer volumes of the plurality can be associated with different permissible sets of actions, wherein a first buffer volume is associated with bulk movement through an environment; a second buffer volume is associated with unloading matter; a third buffer volume is associated with excavating matter; and/or any other matter.

The buffer volume module 541 preferably generates the buffer volumes from a geometric primitive (e.g., sphere, prism, etc.), but can additionally or alternatively generate the buffer volumes from a convex hull of the object (e.g., determined from a geometric model of the object, a scan of the object, etc.), and/or otherwise generate the buffer volumes.

In a first example, a geometric model of the ego vehicle can be used to determine the buffer volume for a component of the ego vehicle. The geometric model can be: received from the manufacturer, generated from a geometric scan of the vehicle (e.g., using LiDAR, photogrammetry, etc.), and/or otherwise determined. The geometric model of the vehicle and/or components thereof can be determined based on data associated with the vehicle (e.g., imagery, depth measurements, point clouds, manufacturer spec, etc.). In an illustrative example, a 3D model of the vehicle can be determined based on a LiDAR scan. The model of the vehicle can include dimensions, articulated structures, bounding volumes, degrees of freedom, a reference coordinate system, and/or any other model component. In this example, the buffer volumes can be an inflation of all or portions of the geometric model, encompass the geometric extents of the geometric model, and/or be otherwise determined.

In a second example, the end effector buffer volume can be a swept volume extending along the position set of the end effector.

In a third example, each object is assigned a buffer volume based on a scaled geometric primitive. In a first example, the object buffer volume can be a swept volume extending along the predicted position set of the object within the environment. In a second example, an object buffer volume can be a volume surrounding the object at each of a set of timesteps.

However, the buffer volumes can be otherwise generated.

The buffer volume is preferably generated based on the position set (e.g., trajectory) of the object (e.g., ego vehicle component, object, etc.), but can alternatively be generated independent of the object position set.

The buffer volume module 541 can compute, select, predict, and/or otherwise determine the buffer volumes. The buffer volumes can be predetermined, static, dynamically determined (e.g., based on the operational context, object-specific parameters, distribution of possible positions within the control window, component criticality, calibration uncertainty, etc.), and/or otherwise determined. In an example, the buffer volumes can have a predetermined size and shape (e.g., the same buffer volume scale for every object, the same buffer volume scale for different instances of the same object class, assigned a scale that encompasses the object's bounding box, different scales for different criticality, etc.). The buffer volumes can be symmetric or asymmetric (e.g., larger in the direction of travel).

In a first variant, the buffer volume is collectively formed from a plurality of safety units (e.g., primitives). In an example, the boundary of each object is seeded with a plurality of safety units.

In a second variant, the buffer volume is determined based on and encompasses the object's bounding box or detected geometry is assigned to the object. The buffer volume can be centered at the object's geometric center, kinematic center, and/or any other reference point.

In a third variant, the buffer volume is determined based on a convex hull of the object. The convex hull of the object can be determined using segmentation or hull generation, be retrieved, and/or otherwise determined. In an example of the third variant, the convex hull can be uniformly or non-uniformly expanded by a predetermined distance to form the buffer volume.

In a fourth variant, the buffer volume parameters (e.g., size, placement) can be computed based on predicted kinematics (e.g., acceleration, velocity, trajectory, etc.) for the object. In an example of the fourth variant, the buffer volume is inflated as a function of the object speed and/or heading.

In a fifth variant, the buffer volume can be dynamically determined based on the operational context of the object. The operational context can be determined based on: the state of the object (e.g., pose, kinematics, heading, predicted goal, predicted trajectory, mass (e.g., of a vehicle component, of matter being manipulated by a vehicle component, etc.), inertia, torque, object class, the configuration of a multi-jointed actuator, etc.); the stopping capabilities of the object (e.g., determined based on the object mass, object momentum, etc.); the predicted interaction between the ego vehicle and the object (e.g., the current task being executed, whether the ego vehicle will be physically interacting with the object, avoiding the object, etc.); the terrain parameters that the object is resting upon (e.g., geometry, stability, etc.); control instructions received from the objects; locations of exclusionary regions; and/or any other parameters.

In a first specific example, each object can be assigned a default buffer volume (e.g., with a default size, default distance from the object, etc.) that is adjusted (e.g., shrunk, expanded, etc.) based on the respective operational context. In an illustrative example, the buffer volume around the dump truck bed is shrunk when the ego vehicle is loading the dump truck (e.g., when the ego vehicle's end effector is impinging into the dump truck bed), and expanded when the ego vehicle is finished loading the dump truck.

In a second specific example, the buffer volume surrounding the ego vehicle component is dynamically determined based on the respective ego vehicle component calibration uncertainty.

In a third specific example, the buffer volume surrounding a detected object in the environment is dynamically determined based on the calibration uncertainty of the vehicle sensors.

In a fourth specific example, the buffer volume surrounding an end effector (e.g., excavator bucket) can be smaller when the end effector is retracted and be larger when the end effector is extended (e.g., to accommodate for changes in inertia and torque).

In a fifth specific example, the buffer volume can include a set of geometric primitives located at detected object positions within the world representation. The dimensions of each geometric primitive can be determined based on a predicted operational context for the respective detected object and/or otherwise determined.

However, the buffer volume module 541 may be otherwise configured.

The fallback control module 542 functions to determine fallback control instructions that are used in lieu of the primary control instructions and/or override the primary control instructions when the primary control instructions fail the safety evaluation. Additionally or alternatively, the fallback control instructions can be used when a machine fault is detected (e.g., an actuator produces an error code, a prediction confidence falls below a threshold, etc.), and/or otherwise used.

The fallback control instruction set can be used when the primary control instructions fail a collision evaluation, when a system fault occurs (e.g., when the main compute fails, when a perception sensor fails, when an end effector fails, etc.), when the primary control instructions have an uncertainty score higher than a threshold, and/or any other circumstances.

The fallback control module 542 is preferably deterministic but can alternatively be stochastic. The fallback control module 542 can calculate, select, look up, retrieve, predict, and/or otherwise determine the fallback control instructions. The fallback control module 542 can generate the fallback control instructions using: Model Predictive Control (MPC), sampling-based trajectory generation (e.g., RTT, PRM, motion primitives, etc.), optimization based methods (e.g., direct collocation, direct shooting, CHOMP, STOMP, etc.), graph-search based methods (e.g., A*, Dijkstra, D*, time-expanded graphs), geometric planners (e.g., splines, polynomial trajectory generation, etc.), learning-based approaches (e.g., MLP, generative models, etc.), Lyapunov-based braking controller, and/or any other methods. In a first example, the fallback control module 542 can calculate a spline between a start and end condition. In a second example, the fallback control module 542 can simulate the ego vehicle's momentum at a point in the position set by setting all control commands to zero and determining whether the resulting stop point collides with any obstacles. In a third example, the fallback control module 542 can use MPC with a collision-free requirement as a constraint to determine the fallback control instructions.

The fallback control module 542 can determine the set of fallback control instructions based on the world representation, the buffer volume sets, sensor measurements, the ego vehicle kinematic state (e.g., current ego vehicle state, future ego vehicle state, vehicle kinematics, pose of jointed actuators, mass, inertia, torque, etc.), the collision horizon (e.g., timing of the anticipated collision), the type of collision (e.g., self-collision, external intersection, stability risk, etc.), stable regions and/or unstable regions, the primary control instructions (e.g., primary control instructions being executed, etc.), mass of contents manipulated by an end effector (e.g., estimated mass), and/or any other factors.

The fallback control instructions can include: a predetermined action (e.g., emergency stop; brake the drive actuators; halt the construction actuators; etc.), a fallback position set (e.g., a deceleration position set with a collision-free stop path, a deceleration position set to maintain vehicle stability, a stopping position set to maintain vehicle stability, fallback trajectory, etc.), a set of waypoints, a set of modulation instructions (e.g., velocity modulation, acceleration modulation, etc.), a target velocity (e.g., velocity of 0) over a target distance or time duration (e.g., to impose a gradual stop); a deceleration profile; operational constraints (e.g., permitted activity envelopes, actuator motion constraints, etc.); cached fallback instructions (e.g., a prior primary control instruction set, cached deceleration trajectories, etc.); a user notification (e.g., on the vehicle, at a user interface within the vehicle cab, at a user output mounted to the vehicle exterior, at an application, at a fleet management system, at a teleoperator interface, etc.); a set of fallback control instructions determined by the CMB system (e.g., permitted actuator range of motion, trajectories, etc.; based on the primary control instructions, based on the primary control instructions currently being executed, based on when the collision is anticipated to occur, etc.); a set of constraints (e.g., preventing actuator actuation, constraining the set of actions the actuators can perform, constraining the actuator's range of motion, etc.); and/or any other type of control instruction. In an example, the fallback control module 542 can be the fastest stable stopping action. In a specific example, the fallback control module 542 can include stopping the vehicle in place and/or within an overlapping position of the vehicle's original footprint, stopping the end effectors as quickly as possible without losing stability, and/or implementing any other emergency stop.

The fallback control instructions can be stored (e.g., for a predetermined period of time, such as one control timestep, two control timesteps, etc.); discarded when the primary control instructions pass the safety evaluation; passed with the primary control instructions to a downstream process (e.g., the motion controller); and/or otherwise managed. The fallback control instructions can be: stored by the CMB, stored by the motion controller, and/or stored by any other system. The fallback control instructions are preferably determined by the CMB system, but can additionally or alternatively be determined by the behavior model and/or by any other model.

The fallback control instructions can be executed in response to occurrence of an emergency state, when the decision module decides to use the fallback control instructions, when a user triggers the fallback control instruction (e.g., by hitting an e-brake), and/or when any other condition is met. Examples of emergency states can include: a collision (e.g., detected, predicted), a hardware failure (e.g., actuator, sensor, processor, power system, etc.), feedback failure (e.g., loss of feedback, corrupted feedback, delayed feedback, etc.), software fault (e.g., exception, heartbeat timeout, invalid control input, etc.), control degradation (e.g., tracking error, oscillatory behavior, unstable behavior, actuator saturation, etc.), safety constraint violations (e.g., kinematic constraints; exceeding force, torque, or speed limits; etc.), communication failure (e.g., loss of communication between modules, control instructions loss of connection to remote processor and/or operator, etc.), confidence or uncertainty exceeding a threshold, and/or any other emergency states.

The fallback control instructions can be determined: by default (e.g., continuously), in response to execution of a set of motion control instructions, in response to a probability of collision exceeding a predetermined threshold, and/or otherwise determined. The fallback control instructions can be determined for each control timestep, at a faster rate than the control timestep (e.g., wherein multiple fallback control instruction sets are determined for each primary control instruction set), at a slower rate than the control timestep, periodically (e.g., at an interval of less than 10 seconds, 10-50 seconds, etc.), and/or at any other time.

A fallback control instruction set can be determined for: each primary control instruction set, each waypoint in the primary control instruction set, and/or for any other primary control instruction set or subelement thereof.

The fallback control instruction set can be calculated in parallel with predicting behavior (e.g., of the ego vehicle, objects in the environment, collisions, etc.), processing sensor data, executing control instructions, and/or at any other time. In an example, the fallback control instruction set can be generated for the next timestep concurrently with the motion control module executing control instructions for the current timestep.

However, the fallback control module 542 may be otherwise configured.

The collision detection module 543 functions to identify collisions.

The collision can be determined between two or more buffer volume sets, a buffer volume and a position set (e.g., primary position set, fallback position set, etc.), and/or any other entities. In an example, the collision detection module 543 can determine if a position set will result in a collision between the ego vehicle and a buffer volume. The buffer volume sets used to determine the collision can include: a buffer volume set for a primary ego vehicle component and one or more buffer volume sets for secondary objects, and/or include other buffer volumes. The primary ego vehicle component can be a primary object that moves relative to a secondary object, the world, and/or any other reference point. Examples of primary ego vehicle components can include an end effector, jointed actuator, the ego vehicle as a whole, and/or any other ego vehicle component. The secondary object can be a second ego vehicle component (e.g., ego vehicle body, drivetrain, etc.), an object in the environment (e.g., surrounding the ego vehicle), and/or any other object. The evaluation is preferably performed for the next control timestep, but can alternatively be performed for a predetermined time horizon (e.g., shorter than or longer than the control timestep), and/or for any other period of time.

The collision detection module 543 is preferably deterministic but can alternatively be stochastic. The collision detection module 543 can use geometric intersection checks, such as closed-form intersection tests (e.g., primitive-primitive intersection test, feature-feature interaction test, etc.), physics-based methods (e.g., using rigid dynamics, constraints, mathematical equations, physical laws, etc.), rule-based methods, separating axis methods, distance-based collision checking, hierarchical bounding volume methods, unit-based intersection checks (e.g., volume overlap, voxel overlap, etc.), mesh intersection methods, continuous collision detection, configuration space methods, and/or any other methods.

The collision detection module 543 preferably does not use neural-network based methods, but can alternatively use neural network based methods. In a first example, a collision is detected when the primary buffer volume set and a secondary buffer volume set share a common spatial unit (e.g., voxel, point, etc.). This can be determined using occupancy grids, world representations, and/or any other method. In a second example, a collision is detected when the distance between the primary buffer volume set and a secondary buffer volume set falls below a threshold distance. This can be determined using signed distance fields, GJK, EPA, closest-point algorithms, and/or any other methods. In a third example, a collision is detected using analytic primitive intersections (e.g., sphere-sphere, capsule-capsule, etc.).

In a first variant, the collision detection module 543 evaluates whether the primary buffer volume set (e.g., for the primary ego vehicle component) intersects with any secondary buffer volume set (e.g., for the secondary object).

In a second variant, the collision detection module 543 evaluates whether the fallback control instructions (e.g., for the primary ego vehicle component) collides with any secondary objects. This variant can include: determining a buffer volume set for the fallback position set and evaluating whether the fallback position set buffer volume set intersects with any secondary buffer volume set (e.g., for the secondary object). In variants, the second variant can additionally include determining a second fallback position set for the time step. In an example of the second variant, if a newly calculated fallback position set is unsafe, the system can discard the fallback position set and default to a previously calculated valid position set (e.g., fallback position set or primary position set). In a specific example, to ensure that the previously calculated valid position set remains safe, the system can impose a safety margin around the points in the position set. If the safety margins are impinged upon, the stop is triggered.

The collision detection module 543 can optionally provide feedback to the behavior model when a collision is detected (e.g., when the detected collision will occur, where the collision is detected, etc.), wherein the behavior model can generate an updated primary control instruction (e.g., based on the feedback, independent of the feedback, etc.), be trained based on the feedback, and/or otherwise manage the feedback.

However, the collision detection module 543 may be otherwise configured.

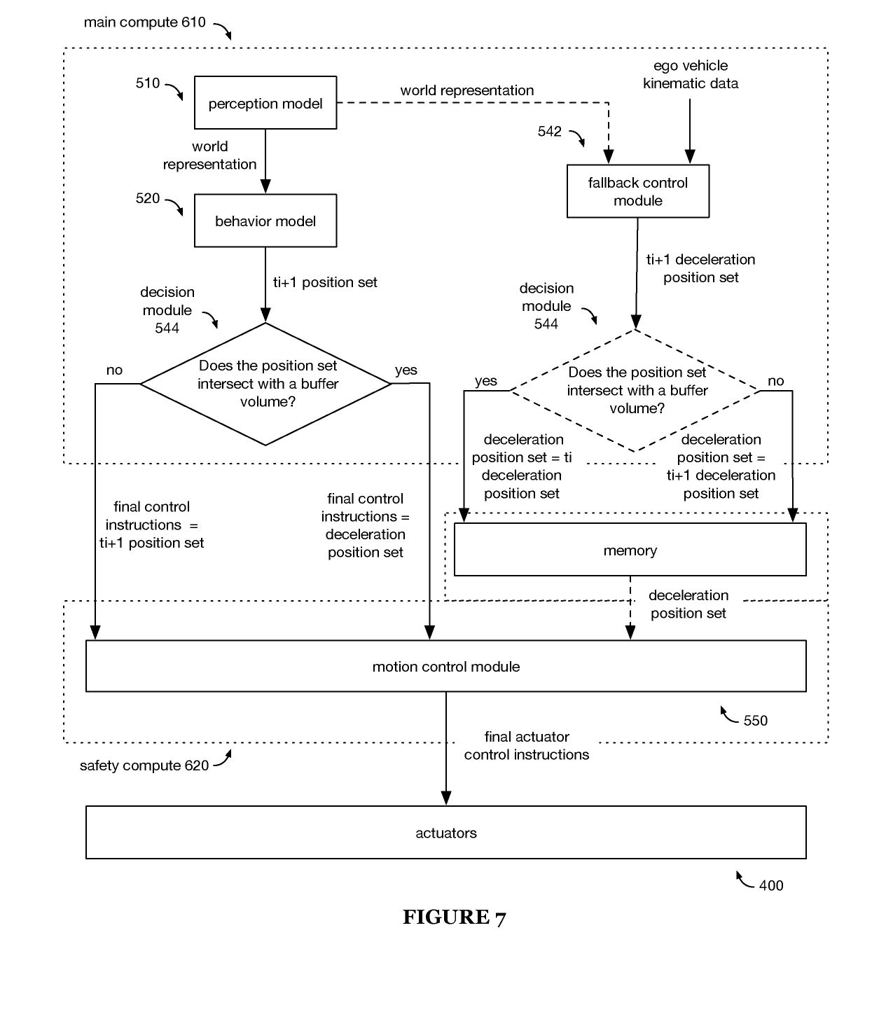

The collision mitigation braking (CMB) system 540 can optionally include a decision module 544, which functions to select which set of control instructions to use (e.g., primary control instructions or fallback control instructions). An example of the decision module 544 is shown in FIG. 7. The decision module 544 can function as a control instruction filter, control instruction selection module, and/or be otherwise configured. The decision module 544 can be a separate module or be incorporated with another module (e.g., collision detection module). The decision module 544 is preferably deterministic but can alternatively be stochastic. The decision module 544 is preferably a binary filter, but can alternatively be a decision tree, ruleset, and/or otherwise configured. The decision module 544 can pass the control instructions to use, specify which control instructions to use, and/or otherwise determine which control instructions to use.

The decision module 544 preferably passes the primary control instructions to a downstream process (e.g., motion controller) only when the primary control instructions satisfy a set of pass conditions, but can alternatively always pass the primary control instructions to the downstream process. The set of pass conditions can include one or more of: passing the collision evaluation (e.g., the primary control instructions are collision free), the uncertainty score for the primary control instructions falling below a threshold, the primary control instructions satisfying a set of rules, and/or any other pass conditions.

The decision module 544 preferably always passes the fallback control instructions to the downstream process (e.g., motion controller), but can alternatively pass the fallback control instructions to the downstream process when a set of fallback conditions are met. The set of fallback conditions can include the primary control instructions failing the collision check, the fallback control instructions passing the collision check, the fallback control instructions having an uncertainty score lower than a threshold, and/or any other fallback conditions.

The downstream processes can execute the fallback control instruction set when no primary control instruction set is available for the timestep (e.g., default to fallback control instruction set execution), cache the fallback control instruction set (e.g., as fallback instructions for when control instructions are not received for a timestep), and/or otherwise manage the fallback control instruction set. For example, deceleration trajectories can be sent to the safety compute (e.g., the memory of the safety compute, the motion controller, etc.). In a first example, emergency stop fallback control instructions are sent when a collision (e.g., position set \- buffer volume intersection; position set – buffer volume intersection) is detected. In a second example, emergency stop fallback control instructions are sent when a collision (e.g., position set \- buffer volume intersection) is detected in the next predetermined number of seconds (e.g., 1s, 1.5s, 5s, 10s, timeframe determined based on the kinematic capabilities of the machine, etc.), while modulation instructions (e.g., acceleration limits) are sent when a collision is detected later in the trajectory (e.g., 10 seconds or more into the future), which can gradually stop the ego vehicle and optionally buy time for the behavior model to generate an updated position set. In a third example, the CMB system can dynamically determine a permitted activity envelope for an actuator (e.g., by computing the set of actuator poses that avoid the safety buffers) when a collision is detected. In a fourth example, the CMB system can notify a user when a collision is detected (e.g., with or without stopping the vehicle).

However, the decision module 544 may be otherwise configured.

However, the collision mitigation braking (CMB) system 540 may be otherwise configured.

The motion control module 550 functions to generate low-level component instructions (e.g., actuator commands, actuator control instructions, etc.). The component instructions can include commands, setpoints (e.g., operation targets), and/or any other instructions. The component instructions can include: a series of poses, power provision instructions, driver calls, torque commands, force commands, velocity commands, position setpoints, pressure commands, pulse-width modulation commands, current commands, and/or any other commands. The motion control module 550 preferably directly controls the actuators but can alternatively indirectly control the actuators. The motion control module 550 preferably controls the actuators based on control instructions received from the CMB and/or behavior model but can alternatively control the actuators based on other control instructions. The motion control module 550 is preferably deterministic but can alternatively be stochastic. The motion control module 550 is preferably a classical motion controller but can alternatively not be a classical motion controller.

The motion control module 550 can include PID controllers, model-based controllers (e.g., an explicit dynamic model, inverse dynamics controllers), trajectory tracking controllers (e.g., geometric path tracking, Stanley controller, etc.), model predictive control (MPC) controllers, control barrier function (CBF) controllers, neural network policies, a set of control loop layers (e.g., position, velocity, force, impedance, etc.), and/or any other controllers.

The motion control module 550 can determine the actuator commands (e.g., component instructions) based on: the ego vehicle component state (e.g., position, orientation, velocity acceleration, joint angles, hydraulic pressure, etc.), the control instructions (e.g., position sets, trajectory, waypoints, setpoints, velocity targets, etc.), constraints (e.g., joint limits, force limits, stability margins, buffer volumes, etc.), environment parameters (e.g., terrain estimate, mass estimate, etc.), and/or any other basis for determining actuator commands.

The control instructions can include the primary control instructions (e.g., when passed by the CMB system), the fallback control instructions (e.g., when no primary control instructions are passed, when the CMB system specifies that the fallback control instructions should be used, when a fault state is detected, etc.), and/or any other set of control instructions.

In a first example, the motion control module 550 can receive primary control instructions and/or fallback control instructions (e.g., from the CMB system), determine component instructions based on the primary control instructions when received, and determine component instructions based on the fallback control instructions when primary control instructions are not received. In a second example, the motion control module 550 can receive primary control instructions (e.g., from the behavior model), the fallback control instructions (e.g., from the CMB system), and a control instruction selection from the CMB system (e.g., decision module) and determine component instructions based on the control instruction set selected by the CMB system.

The motion control module 550 can receive inputs and/or feedback from vehicle sources including joint encoders, motor current sensors, inertial sensors, limit switches, actuator health signals, and/or any other vehicle sources.

The motion control module 550 can optionally apply a set of safety constraints to the component instructions, including command clamping, rate limiting, emergency stop handling, heartbeat requirement, safe-state fallback, and/or any other safety constraints.

The motion control module 550 is preferably executed on the safety compute but can alternatively be executed on the main compute. The motion control module 550 preferably performs elements of S400 but can alternatively perform elements of any other steps in the method.

However, the motion control module 550 may be otherwise configured.

The operator interface 560 functions to receive user input and/or provide feedback. The operator interface 560 can include displays, controls, remote consoles, wearable devices, and/or any other devices. The operator interface 560 can allow monitoring of control instructions and/or motion, override, approval, supervision, teleoperation, fleet coordination, configuration changes, and/or any other operations. The operator interface 560 can receive data from the set of sensors (e.g., at an accessory).

However, the operator interface 560 may be otherwise configured.

However, the control system 500 may be otherwise configured.

The processing system 600 functions to execute the control system, perform the method, and/or perform other functionalities The processing system 600 is preferably onboard the vehicle, but can alternatively be offboard the vehicle, remote from a work site, arranged on an operator accessory, and/or any other location. The processing system 600 can receive data from the set of sensors, vehicle components, and/or any other components. The processing system 600 can include one or more processing systems.

In variants, the processing system 600 includes: a main compute 610; a safety compute 620; an optional memory 630; an optional communication module; and/or other components.

The main compute 610 functions to execute stochastic processes, dynamically-adjusted processes (e.g., processes that are changed over time, across operation sessions, etc.), uncertified processes, high-compute processes, high-latency processes, and/or other processes. The main compute 610 can execute all or portions of the control system (e.g., as shown in FIG. 7).

In a first variant, the main compute 610 executes the perception models, behavior models, stability models, and CMB system, while the safety compute executes the motion control module.

In a second variant, the main compute 610 executes the perception models, behavior models, stability models, and portions of the CMB system (e.g., buffer volume module, fallback control module, collision detection module), while the safety compute executes the remainder of the CMB system (e.g., decision module) and motion control module.

In a third variant, the main compute 610 executes the entirety of the control system.

The main compute 610 is preferably a non-safety qualified processing system but can alternatively be a certified processing system. The main compute 610 can include one or more processors (e.g., GPUs, TPUs, IPUs, CPUs, microprocessors, ASICs, FPGAs, system-on-chip, etc.). The main compute 610 can be connected (e.g., communicatively, electrically, directly, etc.) to: the set of sensors, the safety compute, and/or any other vehicle components.

However, the main compute 610 may be otherwise configured.

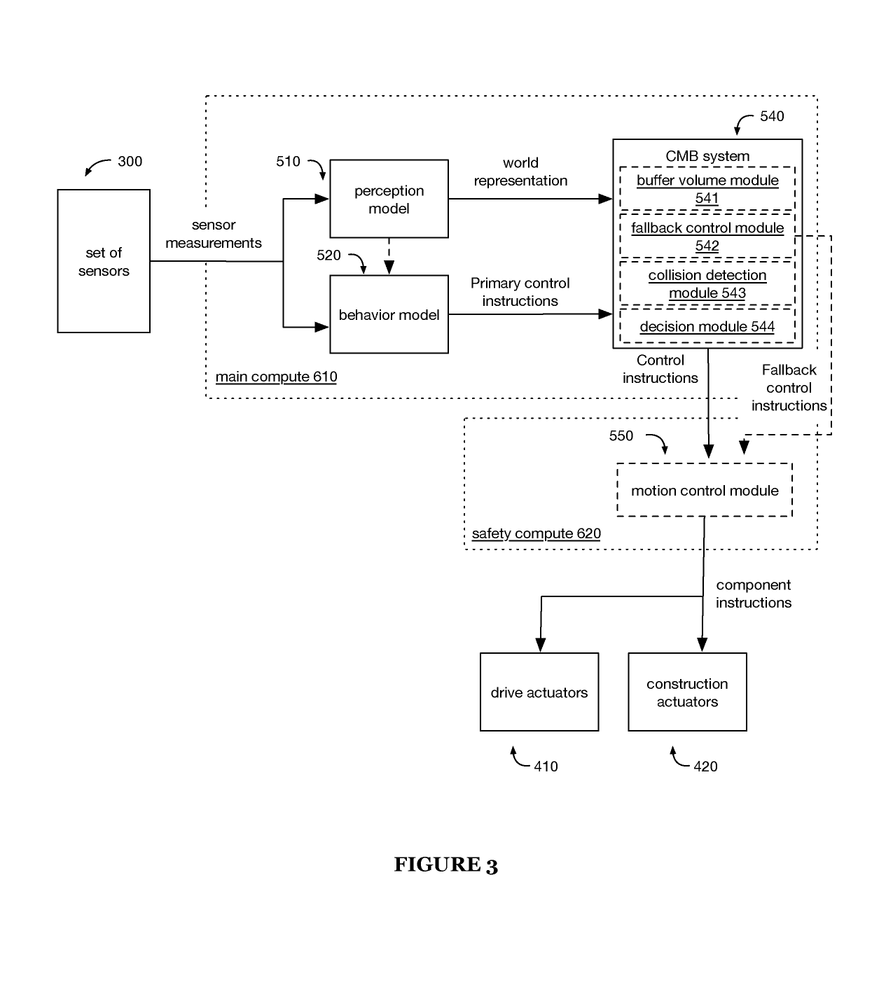

The safety compute 620 functions to execute deterministic processes, static processes, certified processes, low-compute processes, low latency processes, and/or other processes. In an example, the safety compute 620 can execute the motion control module, perform low-level hardware safety checks, cache the fallback control instructions, and/or any other similar functions. The safety compute 620 is preferably a safety-qualified processing system (e.g., certified processor) but can alternatively be otherwise certified. The safety compute 620 can include one or more processors (e.g., CPUs, microprocessors, ASICs, FPGAs, system-on-chip, etc.). In an example, the safety compute 620 preferably has fewer input/output capabilities than the main compute but can additionally and/or alternatively be otherwise configured. The safety compute 620 can include redundant processors or include a single processor. In an example, the safety compute 620 can include two cores running identical code concurrently, allowing the safety compute to compare the outputs of the cores. The safety compute 620 can be connected to actuators (e.g., end effector actuators, drive actuators, etc.), and/or any other vehicle components. The safety compute 620 can be connected directly, indirectly, and/or otherwise connected. In variants, the safety compute 620 can be connected between the main compute and the actuators, such that the main compute is not directly connected to the actuators (and control instructions can pass through the safety compute 620). In an example, control instructions can pass through the safety compute 620 before being executed by the vehicle components (e.g., as shown in FIG. 3 and FIG. 7). In an example, the safety compute 620 can include receiving processed sensor data and/or a set of control instructions from the main compute, processing the set of control instructions at the safety compute (e.g., a set of commands for a actuator from a trajectory or position set), sending the motion controls to a vehicle actuator for execution, and/or any other action.

The safety compute 620 can optionally perform hardware-level integrity checks, including monitoring a controller-area network (CAN) bus, IMUs, a pose estimation system, and/or any other hardware components.

However, the safety compute 620 may be otherwise configured.

The processing system 600 can optionally include a memory 630, which functions to store fallback control instructions, primary control instructions, component instructions, default control instructions, emergency stops, and/or any other information. The memory can optionally store all or portions of the control system (e.g., models, modules, etc.). The memory 630 can store the information: for a predetermined number of control timesteps (e.g., one, two, etc.), for a predetermined amount of time, until a predetermined event occurs (e.g., until a newer fallback control instruction is received, until a newer primary control instruction is received, etc.), for a sliding time window, and/or for any other period of time. In an example, the memory 630 can store the most recent collision-free deceleration position sets (e.g., trajectory) to be used by the safety compute. The information can be used to generate component instructions when the system encounters a fault (e.g., the main compute fails, a sensor fails, etc.), and/or otherwise used. The memory 630 can be part of the safety compute, part of the main compute, separate from the safety compute, separate from the main compute, and/or otherwise arranged. The memory 630 can be certified as a single unit with the safety compute, can alternatively be part of the safety compute, can be non-safety qualified, and/or be otherwise configured. The memory 630 is preferably communicatively connected to the safety compute but can alternatively not be communicatively connected to the safety compute, can be communicatively connected with the main compute, and/or otherwise connected. However, the memory 630 may be otherwise configured.

The processing system 600 can optionally include a communication module, which functions to communicate with one or more endpoints (e.g., a remote computing system, central platform, other vehicles, etc.). The communication module can be wired or wireless. The communication module can include: a transceiver, network interface device, antenna, chip set, and/or any other suitable communication components. The communication module can support Bluetooth, Bluetooth Low Energy, ultra-wideband, satellite, Wi-Fi, and/or any other suitable communication protocols or standards. However, the communication module may be otherwise configured.

However, the processing system 600 may be otherwise configured.

4. Method

As shown in FIG. 4, variants of the method can include: sampling a set of sensor measurements S100; determining a world representation from the set of sensor measurements S200; determining a set of buffer volumes S300; determining position set volumes based on a set of control instructions S400; evaluating collisions between the position set volume and the set of buffer volumes S500; and determining a set of final control instructions based on the collision evaluation S600. The method functions to enforce compliant (e.g., collision-free, safe, etc.) vehicle operation.

In variants, the method can ensure compliant vehicle operation even when using uncertified behavior models for primary control instruction generation. In an example, the method can detect collisions between the vehicle position set (e.g., output by the behavior models) and objects in the environment, and automatically execute a fallback position set (e.g., a kinematically stable emergency stop). The method is preferably performed using the system described above, but can alternatively be performed using any other suitable system.

In an illustrative example, the method can include: sampling a set of measurements (e.g., using a set of sensors); determining a world representation from the set of measurements (e.g., using a set of perception models); determining a set of primary control instructions based on the set of measurements (e.g., using a set of behavior models, directly from the set of measurements or using the world representation); determining a set of fallback control instructions (e.g., including an inertially-stable stop position set) based on the world representation; determining a set of object buffer volumes based on the world representation (e.g., for each of a set of objects detected in the environment, for each of a set of ego vehicle components, etc.); determining a set of primary buffer volumes (e.g., position set volumes) based on the primary control instructions (e.g., based on the primary position set); evaluating collisions between the primary buffer volumes and the set of object buffer volumes; generating actuator controls based on the set of primary control instructions when no collisions are detected; generating actuator controls based on the set of fallback control instructions when collisions are detected; and controlling vehicle actuators based on the generated actuator controls. An example is shown in FIG. 4. In variants, the fallback control instructions can be cached and subsequently used when system faults occur (e.g., main compute failure, sensor failure, etc.). However, the method can be otherwise performed.

Sampling a set of sensor measurements S100 functions to sample the state of the environment surrounding the vehicle. S100 is preferably performed by the sensor set, but can alternatively be performed by offboard sensors and/or any other component. S100 can include measurements of the environment, the vehicle (e.g., component states, joint states, etc.), and/or of any other object. Sampling a set of measurements S100 functions to determine the environmental state, determine vehicle states (e.g., exteroceptive vehicle states, etc.), and/or any other suitable set of states. The measurements are preferably measurements of the environment and/or exteroceptive measurements (e.g., estimating vehicle state using external or indirect environmental measurements), but can additionally or alternatively be direct measurements of the vehicle state, be proprioceptive measurements (e.g., estimating vehicle state using internal sensors or direct measurements), and/or be other measurements. Examples measurements that can be sampled can include: environment state measurements (e.g., terrain, topography, visual appearance, geometry, temperature, pressure, humidity, soil density, etc.); vehicle state measurements (e.g., vehicle kinematics, vehicle dynamics, end effector pose, joint angle, temperature, pressure, steering angle, damper positions, etc.); and/or other measurements. The environmental state and/or vehicle state can be directly measured, being inferred (e.g., from images, LiDAR point clouds, etc.), and/or otherwise determined.

Sampling a set of measurements S100 can include sampling a set of primary measurements, sampling a set of secondary measurements, sampling a set of vehicle actuator measurements, and/or sampling any other set of measurements.

The set of primary measurements can be sampled by a set of primary sensors. Examples of primary sensors that can be used include: accelerometers, IMUs, gyroscopes, odometers, temperature sensors, pressure sensors, cameras, LiDAR, radar, and/or any other set of sensors. The set of primary sensors are preferably mounted onboard the vehicle, but can alternatively be offboard the vehicle.

The set of secondary measurements can be sampled by a set of safety sensors. Examples of safety sensors that can be used in the safety sensor set include accelerometers, IMUs, gyroscopes, odometers, temperature sensors, pressure sensors, cameras, LiDAR, radar, and/or any other set of sensors. The set of safety sensors is preferably different from the set of primary sensors, but can alternatively be the same sensors. The set of safety sensors can be physically collocated with the set of primary sensors, but can alternatively be arranged in different locations relative to the vehicle. The set of safety sensors is preferably connected to a redundant circuit (e.g., a different power and/or data circuit from the set of primary sensors), but can additionally or alternatively be connected to the same circuit(s). The safety sensors are preferably more robust than the primary sensors (e.g., ruggedized, less susceptible to noise, less complex, high uptime, etc.), but can alternatively be equally or less robust. In a specific example, the set of safety sensors can be limited to proprioceptive sensors (e.g., IMUs, encoders, pressure sensors, etc.).

However, sampling a set of measurements S100 may be otherwise performed.

In variants, the method can optionally include determining a vehicle state S150, which functions to determine the current vehicle condition and motion. The vehicle state can include pose (e.g., position, orientation, etc.), kinematics (e.g., velocity, acceleration, etc.), propulsion state (e.g., track speed, angular rate, etc.), actuator state (e.g., steering angle, brake position, throttle position, gear position, etc.), vehicle instability, system health and status (e.g., engine temperature, battery voltage, fault flags for sensors or components, etc.), and/or any other vehicle state information.

The vehicle state can be determined from vehicle state measurements sampled by a vehicle sensor set, or otherwise determined. The vehicle sensor set preferably samples direct measurements of the vehicle state for proprioceptive estimation, but can additionally or alternatively sample indirect measurements for exteroceptive estimation. The vehicle sensor set preferably directly measures the vehicle state, but can alternatively indirectly measure the vehicle state (e.g., samples an image of the vehicle component and predicts the vehicle component state). The vehicle state measurements can be used to: predict a future vehicle state (e.g., wherein the vehicle component state creates an effect on the vehicle or external environment after a delay or lag, such as 5 microseconds), determine the current vehicle state, and/or otherwise used.

The vehicle sensor set is preferably different from the primary sensor set and secondary sensor sets, but can alternatively be a subset of the primary and/or secondary sensor sets, a superset of the primary and/or secondary sensor sets, and/or otherwise related to the primary and/or secondary sensor sets. The vehicle sensor set can measure steering angle, brake position, accelerator position, gear position, suspension position and/or load, encoders (e.g., wheel encoders, cab encoders, end effector encoder, etc.), component acceleration, temperature, pressure, motor current, and/or any other vehicle parameters.

Examples of vehicle sensors that can be used can include: encoders (e.g., joint encoders, wheel encoders, cab encoders, etc.), IMUs, gyroscopes, pressure sensors, temperature sensors, torque sensors, force sensors, hall effect sensors, voltage sensors, flow rate sensors, and/or any other vehicle sensors. The vehicle sensors are preferably directly mounted to the component they are monitoring, but can alternatively be otherwise mounted.

The vehicle state can be determined on the secondary compute, primary compute, separate compute, and/or any other processing system. The vehicle state is preferably updated at a faster rate than trajectory determination, but can alternatively be updated at the same rate or at a slower rate.

In a first variant, determining a vehicle state S150 can include detecting vehicle instability, which functions to determine when the vehicle is or will become difficult or impossible to control, or will unexpectedly deviate from the primary trajectory.

The vehicle instability can be determined based on current center of mass, kinematics (e.g., velocity, acceleration, jerk), pose, operational state (e.g., all clear, faults, inoperational, etc.), and/or any other vehicle state parameter. The vehicle instability can be determined for the vehicle as a whole, individual vehicle components (e.g., end effector, arm, etc.), and/or any other elements of the vehicle. The vehicle instability is preferably determined from vehicle state measurements sampled by the vehicle sensor set (e.g., vehicle actuator positions, vehicle actuator state, control input position, etc.) and/or the secondary sensor set, but can additionally or alternatively be received from an external system (e.g., monitoring vehicle dynamics, etc.) and/or otherwise determined.

The detected vehicle instability can include longitudinal slip, lateral slip, load transfer errors (e.g., excessive front loading, excessive rear loading), yaw rate errors (e.g., loss of traction on one side, steering malfunction, etc.), roll instability (e.g., loss of tire contact, rollover, etc.), pitch instability (e.g., detecting excessive nose dive, rear squat, etc.), suspension kinematics errors (e.g., pump steer, suspension malfunction, etc.), brake imbalance, and/or any other vehicle instability.

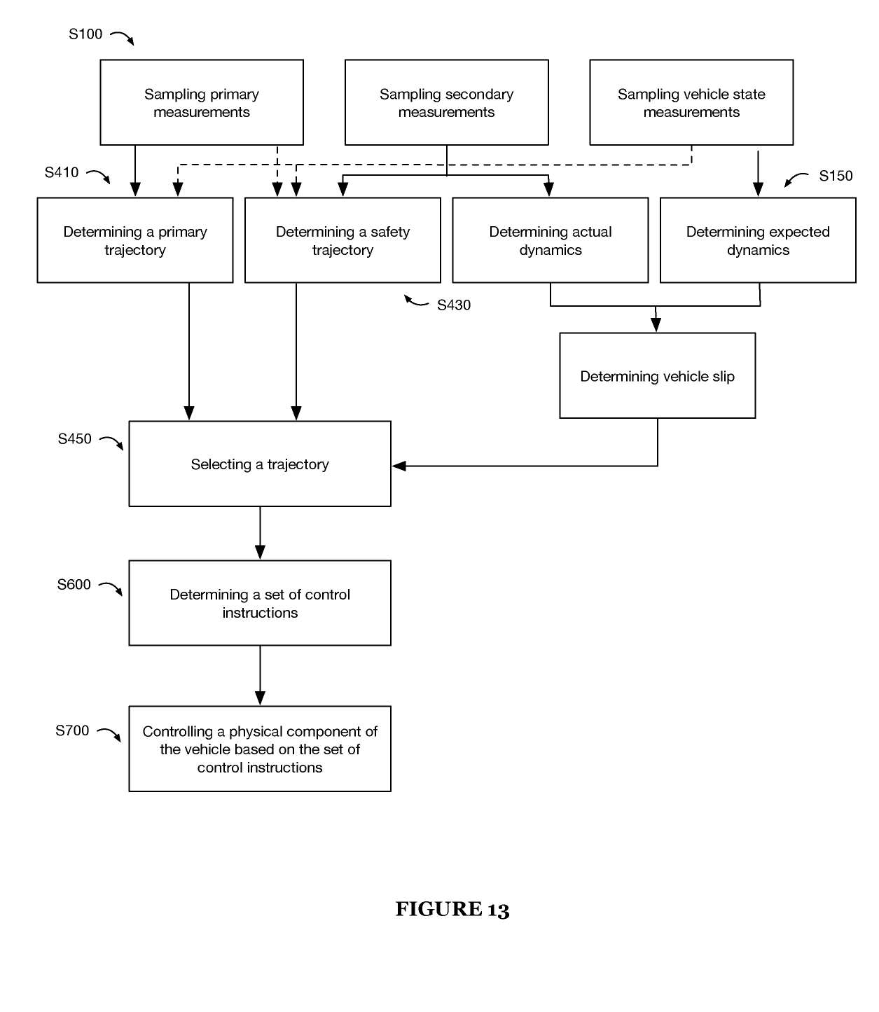

Determining the vehicle instability can include: determining actual vehicle dynamics (e.g., how the vehicle is actually moving at the current timestep); determining expected vehicle dynamics (e.g., how the vehicle was expected to move at the current timestep); and detecting slip based on a difference between the actual and expected vehicle dynamics. An example is shown in FIG. 13.

The actual vehicle dynamics can be directly measured, predicted from current measurements, and/or otherwise determined. The actual vehicle dynamics are preferably determined based on current measurements, but can alternatively be determined based on historic measurements. The actual vehicle dynamics are preferably determined based on current vehicle state values, but can additionally or alternatively be determined based on any other set of dynamics parameter values or physical priors. The current vehicle state values are preferably determined based on measurements from the safety sensor set (secondary measurements), but can additionally or alternatively be determined based on measurements from the primary sensor set. In variants, the current vehicle state values are preferably not determined based on the vehicle sensor set, but can alternatively be determined based on the vehicle sensor set. Current vehicle state values are preferably directly sampled from the vehicle (e.g., with an IMU, a gyroscope, location sensor, encoder, etc.), but can additionally or alternatively be predicted (e.g., from visual odometry extracted from the ambient environment, from suspension height, estimated based on the amount of mass added or removed from the vehicle, etc.), and/or otherwise determined.

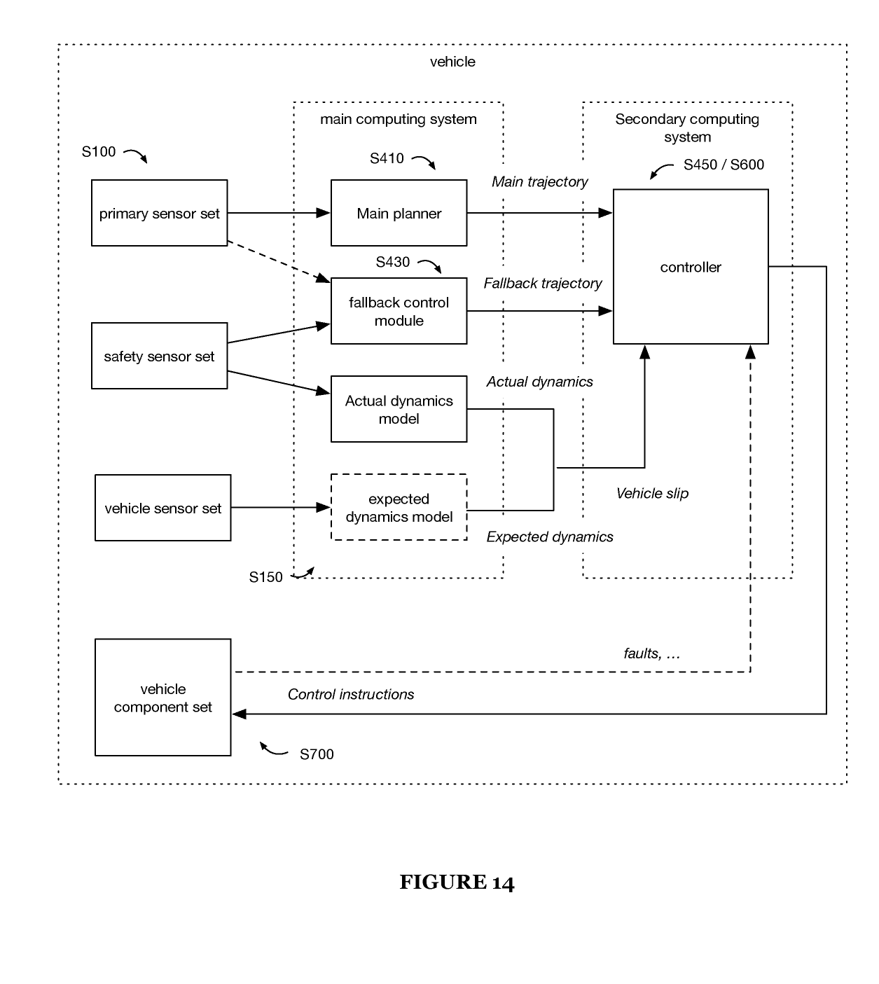

The actual vehicle dynamics can be determined using an actual dynamics model (e.g., example shown in FIG. 14), and/or any other model. The actual dynamics model is preferably a physics-based dynamics model, but can additionally or alternatively be a machine learning model (e.g., trained to learn the vehicle dynamics), and/or have any other model architecture. The actual dynamics model can be a Kalman filter (e.g., EKF), rigid-body dynamics model (e.g., rigid body dynamics with lie group integration), complementary filter (e.g., SE3), a learned dynamics model (e.g., a reinforcement learning model), and/or any other model.

However, the actual vehicle dynamics can be otherwise determined.

The expected vehicle dynamics can be determined from prior control input states (e.g., steering angle, throttle position, etc.) from a prior timestep, and/or from other data. For example, the expected vehicle dynamics can be determined from control input states from l microseconds ago, wherein l is control lag. The expected dynamics are preferably for the same timeframe as the actual vehicle dynamics (e.g., both computed for t_i), but can alternatively be determined for different timeframes. The expected dynamics are preferably determined based on prior measurements (e.g., lag-adjusted prior time, delayed base time, etc.), but can alternatively be determined based on current measurements. The expected dynamics are preferably determined based on vehicle sensor measurements (e.g., proprioceptive measurements of control input positions), but can additionally or alternatively be determined based on secondary sensor measurements, primary sensor measurements, and/or any other measurements.

The expected vehicle dynamics can be determined using an expected dynamics model (e.g., example shown in FIG. 14), and/or any other model. The expected dynamics model is preferably different from the actual dynamics model, but can additionally or alternatively be the actual dynamics model, have the same architecture as the actual dynamics model, and/or be otherwise related to the actual dynamics model. The expected dynamics model is preferably a physics-based dynamics model, but can additionally or alternatively be a machine learning model (e.g., trained to learn the vehicle dynamics), and/or have any other model architecture. The expected dynamics model can be a Kalman filter (e.g., EKF), rigid-body dynamics model (e.g., rigid body dynamics with lie group integration), complementary filter (e.g., SE3), a learned dynamics model (e.g., a reinforcement learning model), and/or any other model.

However, the expected vehicle dynamics can be otherwise determined.

Detecting slip based on a difference between the actual and expected vehicle dynamics functions to identify vehicle instability. Slip can be detected when the actual vehicle dynamics differ from the expected vehicle dynamics above a threshold value (e.g., predetermined value, a dynamically determined threshold based on vehicle speed or acceleration, etc.; example shown in FIG. 14), and/or otherwise determined. In an example, a deviation between the actual dynamics (e.g., determined based on current vehicle state) and the expected dynamics (e.g., determined based on control input positions) beyond a threshold proportion or value can be indicative of traction instability (e.g., slippage) and be treated as a fault or error (e.g., dynamics error). In specific examples, this can cause the system (e.g., controller) to transition to generating control instructions based on the fallback trajectory instead of the primary trajectory. In a first example, lateral slip can be detected when the predicted lateral acceleration differs from the actual lateral acceleration (e.g., when the slip ratio between the predicted and actual acceleration surpasses a threshold). In a second example, lateral slip can be detected when the predicted velocity of the vehicle differs from the actual velocity (e.g., when the slip ratio between the predicted and actual velocity surpasses a threshold). In a specific example, the slip ratio can be defined as s = (ωr - v) / v, where s is slip, ω is the angular velocity of the wheel or track, r is the effective radius of the wheel or track, and v is the vehicle’s theoretical speed.

In a second variant of S150, the vehicle instability can be detected when a measurement of a vehicle component exceeds a threshold. In an example load transfer errors can be detected when the center of gravity shift when braking exceeds a threshold. In an example yaw rate errors can be detected when the resistance on the tracks on one side exceeds the resistance on the tracks on the other side by a predetermined threshold.

However, the vehicle state can be directly measured, computed from measurements, and/or otherwise determined.

However, determining a vehicle state S150 may be otherwise performed.

Determining a world representation from the set of sensor measurements S200 functions to determine the state of the environment. S200 is preferably performed by the perception model(s), but can alternatively be performed by the behavior model(s) and/or by any other model. S200 can be performed once for each planning timestep, multiple times for each planning timestep, and/or at any other frequency. The world representation can include a set of object detections, object trajectories (e.g., historical, predicted, etc.), object states, and/or any other representations. However, determining a world representation from the set of sensor measurements S200 may be otherwise configured.

Determining a set of buffer volumes S300 functions to define volumes that the vehicle should avoid. An example of determining a set of buffer volumes S300 is shown in FIG. 6. The buffer volumes can be determined: at a predetermined frequency, when a trigger event occurs (e.g., when an external vehicle moves, when a vehicle component moves, etc.), and/or at any time. S300 can be performed every planning timestep, multiple times for each planning timestep, and/or at any other time. S300 can be performed by the control system, more preferably performed by the buffer volume module in the collision mitigation braking (CMB) system, but can alternatively be performed by the stability module, the behavior model, or any other suitable system. S300 is preferably performed on the main compute, but can alternatively be performed on the safety compute or any other suitable compute.

The set of buffer volumes can include or be determined from an object's geometry, a margin around the object, and/or any other object geometric extent. The object geometric extent can be part of the set of object detections or separately determined. The object geometric extent can be determined from the sensor measurements (e.g., using segmentation algorithms, clustering algorithms, hull generation algorithms, surface mesh reconstruction, signed distance functions, etc.), retrieved from storage (e.g., a 3D model for the vehicle component, for the object class, etc.), and/or otherwise determined. The object geometry is preferably determined by the perception model(s), but can alternatively be retrieved from a manufacturer, generated from a scan of the object, determined by the CMB system, and/or any other method. The buffer volumes can trace the boundaries of the objects, be anchored to a point of the object (e.g., a center of mass, a center of geometry, etc.), vary based on the subcomponent of the object, vary based on the heading of the object (e.g., have a wider safety margin in the direction of travel and a smaller safety margin in the opposite direction), and/or any other configuration.

The buffer volumes can be for a single timepoint, for a period of time (e.g., a spatiotemporal buffer volume, a swept volume, etc.), and/or for any other set of times. When the buffer volume is for a period of time, the buffer volume can have the same dimensions over the swept volume (e.g., the same width, height, etc.), or have varying dimensions over the swept volume. In the latter variant, the dimensions can vary based on intent, kinematics, and/or other parameters at the corresponding timepoint, and/or be otherwise determined.

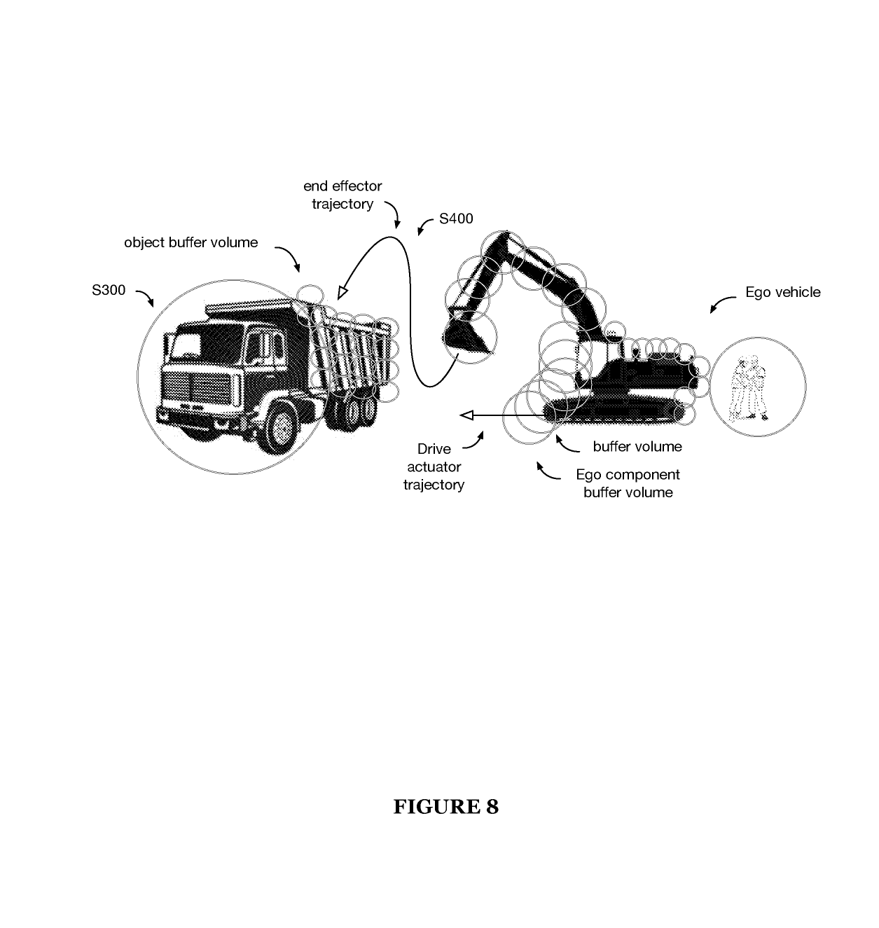

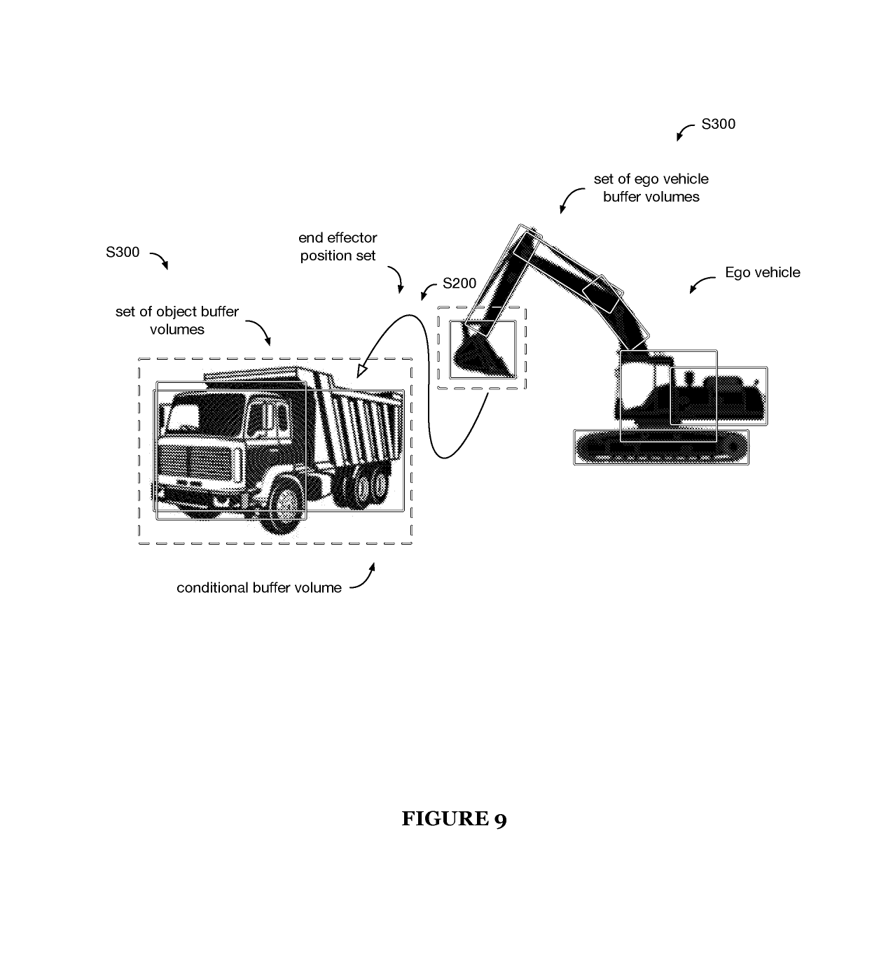

Buffer volumes can be defined around: the object perimeter, the ego vehicle perimeter, position set (e.g., the position set itself or a distribution of possible positions), and/or any other set of spatial positions. Each buffer volume can be defined by: a set of buffer primitives (e.g., spheres or another geometric shape; e.g., as shown in FIG. 8 and FIG. 9) arranged along the object perimeter; a continuous margin; a single buffer primitive (e.g., buffer unit); the object's geometry itself; constraints on future expected motion; constraints imposed by available motions given the current pose; a set of convex hulls, and/or be otherwise constructed.

The buffer primitives can be: spheres, obloids, prisms (e.g., cuboids, pentahedrons, etc.), cylinders, and/or any other shape. Additionally or alternatively, the safety units can be point clouds, meshes, distributions (e.g., occupancy distributions, etc.), and/or otherwise configured. The buffer primitives can be symmetric or be asymmetric. The buffer primitives parameters (e.g., dimensions, density, etc.) can extend further in the direction of vehicle component travel, be determined based on the vehicle component parameters, based on risk, based on adjacent objects (e.g., extends further when the adjacent object is a human and extends less far when the adjacent object is another vehicle, etc.), based on a distribution of possible positions (e.g., include more safety units or larger safety units in regions with higher probability of end effector ingress), and/or otherwise determined. The buffer primitives can all have the same shape, or have different shapes. In a specific example, since primitives are incredibly fast to compute, using a set of primitives to model a safety margin around an object can drastically increase the speed of buffer volume determination. Furthermore, since primitive intersections are easy to evaluate (e.g., reduces down to a check), this can increase the collision evaluation speed. In specific examples, the sensor measurement - to collision detection duration can be to collision detection duration can be less than: 500ms, 100ms, 1s, any range defined therebetween, and/or any other suitable duration.

In a first variant, the buffer volume can be defined by a set of safety primitives (e.g., spheres, prisms, etc.) arranged along each object's perimeter, and optionally by the object's geometry itself. In this example, the CMB can identify the object's geometry or boundaries; and seed the object boundaries with a set of safety primitives. The size of the safety primitives can be determined based on object type, kinematics, range of motion, the ego vehicle's planned position set, the external object's predicted position set, and/or any other parameters (e.g., discussed further below). The set of units can be continuous or discontinuous. The positions or density of the safety primitives can be determined based on similar parameters (e.g., higher primitives density in the direction of travel or on high-mobility components, lower primitives density in the opposite direction of travel or low-mobility components, etc.) and/or otherwise determined.

In a second variant, the buffer volume can be defined relative to a point within a bounding box or segment of a detected object (e.g., relative to a center of geometry, center of mass, center of inertia, etc.). In this example, the buffer volume can have a predetermined size, be determined based on the bounding box dimensions (e.g., the buffer volume's radius can be defined by the major or minor dimension of the bounding box), and/or otherwise determined.

In a third variant, the buffer volume includes a continuous margin that extends a predetermined distance from the object surface. In an example, S300 can: identify the object's boundaries (e.g., using segmentation algorithms, clustering algorithms, hull generation algorithms, surface mesh reconstruction, etc.); and grow the object boundary by the predetermined distance.

The buffer volumes are preferably anchored in evaluation space based on the boundaries and/or locations of the objects, but can alternatively be otherwise arranged in evaluation space. The location of the objects can be determined from the sensor measurements (e.g., the center of a bounding box output by an object detector, the boundary of an object segment output by a segmentation module, etc.), and/or otherwise determined. In variants, the buffer volumes can be determined based on a set of volume parameters. The set of volume parameters can include the position, orientation, size, shape, transformation parameters (e.g., dimensions, scale, expansion coefficient, safety margin, deformations, etc.), and/or any other parameters that collectively define the buffer volume. The set of volume parameters can be predetermined (e.g., default values), dynamically determined (e.g., based on operation context), and/or otherwise determined. The set of volume parameters can be determined based on the object state (e.g., kinematics, heading, etc.), the ego vehicle component state (e.g., kinematics, trajectory, etc.), the predicted risk for a given voxel in the world representation, and/or any other suitable input. The set of volume parameters can be looked up, selected, computed (e.g., using a set of equations), predicted (e.g., using a neural network), and/or otherwise determined.

In a first example, the buffer volume shape can be determined based on the identity of the object. For example, the buffer volume shape for a target object (e.g., dump truck) can be determined based on the convex hull of the target object, the buffer volume shape for a non-target object (e.g., human, obstacle, etc.) can be a default primitive geometry (e.g., sphere), and the buffer volume shape for an ego vehicle component can be based on a convex hull of the ego vehicle component.

In a second example, the buffer volume scaling factor (e.g., expansion factor) can be a function of the object's kinematics (e.g., acceleration, velocity, inertia, etc.).

In a third example, the buffer volume deformation direction can be aligned with the object's heading.

In a fourth example, the buffer volume location can be determined (e.g., centered) based on a reference point of the object. Example reference points that can be used can include: the center of geometry, the center of mass, the center of inertia, the center of the bounding box, any other centroid, and/or any other reference point. The volume parameters can additionally and/or alternatively be otherwise determined.

The buffer volume size (e.g., buffer unit radius) can be predetermined, determined based on the object type, the object kinematics, the task type, the physics, rigid dynamics, and/or range of motion of the object's actuators (e.g., end effectors), the control instructions for the external object (e.g., received via vehicle-to-vehicle communication, from fleet management system, etc.), the planning timestep duration, the control timestep duration, mass of contents manipulated by a vehicle component (e.g., estimated mass of contents manipulated by an end effector), and/or any other information.

In a first example, the buffer volume around an external dump truck cab can be larger than the safety margin around the dump truck bed (e.g., as shown in FIG. 8). In a specific example, the buffer volume around the cab can include one buffer unit that encompasses the entire cab, while the safety margin for the bed can be made from multiple smaller units tracing the bed walls. In a second example, the buffer volume around a dump truck can be large during construction (e.g., when a dump truck is not needed), but small and/or detailed during excavation (e.g., when a dump truck is needed). In a third example, the buffer volume around an excavator's bucket is defined by the bucket's range of motion, given the bucket's current configuration. In a fourth example, the buffer volume around a dump truck bed can exclude matter (e.g., dirt) in the dump truck bed and/or include a low-profile buffer volume (e.g., a buffer volume of 0 thickness), enabling the bucket to touch the matter in the dump truck bed. In a fifth example, the buffer volume around a person is larger than the buffer volume around a dump truck bed. In a sixth example, the buffer volume around an object is selected based on the possible positions the object can travel to (e.g., within the discretization timesteps of the trajectories, etc.). This can enable the CMB system to assume that the object is static during the evaluated period. In a seventh example, the buffer volume around an object extends along the object's anticipated position set during the collision evaluation time horizon. In an eighth example, the buffer volume around a vehicle can be determined based on the range of motion of the end effector (e.g., end effector range of motion, swing of the end effector in response to rotation of the base, and/or any other range of motion).

In a ninth example, the buffer volume around a vehicle can be determined based on risk (e.g., of damage, to human safety, and/or any other risk).

The set of buffer volumes can be defined around objects, around ego vehicle components, around regions in the environment, and/or otherwise defined. The buffer volumes can be defined around external objects (e.g., external object buffer volumes), terrain (e.g., ground, hills, etc.), around different components of the ego vehicle (ego component buffer volumes), and/or around any other objects.

In a first variant, the set of buffer volumes includes buffer volumes for external objects (e.g., external object buffer volumes, terrain buffer volumes, external vehicles, structures, people, etc.). In a first embodiment, determining the object buffer volumes can include receiving a set of object detections, each including a bounding box and a set of object-specific parameters (e.g., kinematics, etc.); determining a set of buffer volume parameters for each object detection (e.g., buffer unit radius, buffer unit density, number of buffer units, etc.) using a deterministic computation or lookup (e.g., based on the object-specific parameters); and populating a buffer volume at each bounding box location based on the respective object detection. In a second embodiment, determining the object buffer volumes can include receiving a set of object hulls; determining a set of buffer volume parameters for each object detection (e.g., buffer unit radius, buffer unit density, number of buffer units, etc.) using a deterministic computation or lookup (e.g., based on the object-specific parameters associated with each hull); and populating a buffer volume at each bounding box location based on the respective object detection. In a third embodiment, determining the object buffer volumes can include receiving a set of object detections (e.g., bounding boxes, depth measurements, etc.), each associated with a set of object-specific parameters (e.g., class, kinematics, etc.); retrieving a geometric model of the object; determining a set of buffer volume parameters for each object (e.g., based on the object-specific parameters), and populating the detected object location with the respective geometric model and a buffer volume around the geometric model based on the buffer volume parameters. In an example of the first variant, determining a set of buffer volumes can include determining labels for object motion (e.g., static, stable but capable of motion, moving, etc.), object type (e.g., people, structures, vehicles, utilities, terrain, etc.), risk level (e.g., high risk, low risk, etc.). In a fourth embodiment, determining terrain buffer volumes can include: receiving a map of the terrain (e.g., depth map, etc.); optionally identifying regions of the terrain to be manipulated (e.g., excavated, built upon, etc.); adding buffer volumes around regions of the terrain that will not be manipulated; and not adding buffer volumes around regions of the terrain that will be manipulated. Alternatively, no buffer volumes are added around the terrain.

In a second variant, the set of buffer volumes includes buffer volumes for ego vehicle components (e.g., ego component buffer volumes). The ego component buffer volumes function to prevent self-collisions (e.g., prevent the end effectors from colliding with another part of the vehicle, such as the vehicle cab). Different components of the ego vehicle can include different ego component buffer volumes (e.g., based on the vehicle component type, reparability, criticality to the task, etc.). In an example of the second variant, an excavator boom-arm-bucket assembly can have a first buffer volume, the cab (e.g., operator cabin, cabin with a seat, etc.) can have a second buffer volume, and the treads can have a third safety margin (e.g., example shown in FIG. 9). Alternatively, the entire vehicle can have a single safety volume, wherein parameters of the safety volume (e.g., thickness, density, etc.) can vary along the body of the ego vehicle. The end effectors preferably do not have a buffer volume, but can alternatively have a buffer volume.

The ego component buffer volumes can be determined in a similar manner to object buffer volume determination, or be otherwise determined. The ego component buffer volumes are preferably anchored in evaluation space based on the boundaries and/or locations of the ego components, and/or be otherwise arranged in evaluation space. The location of the ego components can be determined from the sensor measurements, from the control instructions (e.g., from prior control instructions, from the control instructions generated during this time step, etc.), from component instructions, and/or otherwise determined.

In a first embodiment, determining the ego component buffer volume can include: determining vehicle state (e.g., current or future vehicle state; from the controller, the vehicle's state sensors, from the planner, etc.); optionally determining an intention (e.g., a target operation, current or future intention; from the controller, the planner, an operator, the vehicle's state sensors, etc.); optionally determining the condition of the vehicle's control margin of error (e.g., actuator precision, sensor calibration margin of error, uncertainty, etc.); optionally determining a geometric model of the ego vehicle, configured according to the current vehicle state; determining a set of buffer volume parameters (e.g., buffer unit radius, buffer unit density, buffer unit number, buffer unit locations, etc.); and populating the ego vehicle location with buffer volumes surrounding one or more ego vehicle components. In an example, the vehicle state can be used to determine the pose and configuration of the ego vehicle components relative to the environment, the ego component geometric model can be used to define the physical extent of the respective component, wherein the safety primitives are defined along the boundary of the geometric model.

In a first example, the buffer volume parameters can be determined based on the vehicle state (e.g., heading, velocity, etc.), be predetermined, and/or be otherwise determined. In a second example, an intention can be determined based on the vehicle type, sensor data, the planner, vehicle state, and/or any other suitable input. In an illustrative example where the vehicle is an excavator, the sensors can measure the presence of matter and/or estimated mass of matter manipulated by the end effector, and determine a future intent to release the matter. This example can include decreasing the size of the buffer volume in response to determining a future intent to release the matter in the bucket. In a third example, the target operation can include an intended future operation (e.g., unloading, excavating, etc.). In a fourth example, determining a set of buffer volumes can include determining a buffer volume based on the margin of error of a calibration sensor, such that the buffer volume captures the range of possible positions of the actuator due to the margin of error. In a fifth example, determining a set of buffer volumes can include dynamically increasing the buffer volume in response to detecting fast motion, based on the level of uncertainty of the position increasing with faster motion. In a sixth example, determining a set of buffer volumes can include determining a set of buffer volumes for the arm and bucket of an end effector based on a geometric model of the ego vehicle. In a specific example, the buffer volumes in the set can be connected (e.g., overlap), move relative to each other, be associated with a range of motion, and/or be otherwise connected. In a specific example, the size of the safety volume can depend on the range of motion of the end effector.

Determining a set of buffer volumes S300 can include determining different buffer volume versions for different position set collision evaluations. In an example, S300 can determine a first set of buffer volumes for vehicle position set collision evaluation (e.g., evaluation against the drive actuator position set) and a second set of buffer volumes for end effector position set collision evaluation (e.g., evaluation against the vehicle position set). In an illustrative example, the first set of buffer volumes can include buffer volumes around terrain features (e.g., the ground, mounds of gravel, etc.), while the second set of buffer volumes can lack or exclude buffer volumes around the same terrain features.

However, the determining a set of buffer volumes S300 may be otherwise configured.

Determining position set volumes based on a set of control instructions S400 functions to define the series of positions of the vehicle and/or vehicle component (e.g., end effector) within the environment, optionally with a safety margin. S400 can be performed every planning timestep, multiple times for each planning timestep, and/or at any other frequency. S400 can be performed by the control system, more preferably performed by the buffer volume module in the collision mitigation braking (CMB) system, but can alternatively be performed by the stability module, the behavior model, and/or any other suitable system. An example of determining position set volumes based on a set of control instructions S400 is shown in FIG. 6. S400 can be performed as part of S300 (e.g., wherein the position set volume is a type of buffer volume), or can be performed separately.

The position set volume is preferably defined around the primary position set (e.g., trajectory, single position, etc.) output by the behavior model (e.g., predicted by the behavior model, etc.), but can alternatively be defined around the fallback position set and/or any other position set. The position set volume preferably includes a margin (e.g., buffer zone) around the primary position set, but can alternatively be otherwise defined.

The position set volume is preferably at least as wide as the actuator's width (e.g., the end effector's width), and can optionally include a position set margin beyond the actuator's width. Alternatively, the position set volume can be any suitable width. The actuator's width is preferably known a priori (e.g., using a lookup table, hardcoded into the position set volume determination method, etc.), but can alternatively be sensed, estimated, and/or otherwise determined. The position set margin can be: predetermined (e.g., a predetermined width), determined based on the task, determined based on the end effector's range of motion, computed based on risk (e.g., based on the actuator mass, kinematics, etc.), determined based on a buffer volume (e.g., the ego vehicle buffer volume), determined based on a stability analysis, and/or otherwise determined. In an example, the position set margin can be determined by the actuator's possible positions at each of a set of points within the position set, given the actuator's configuration or state at the given point, the margin of error of the actuator, the actuator's configuration or state at the given point, and/or based on other actuator parameters.

The position set volume can be for an end effector, the ego vehicle, and/or for any other suitable component. In an example, the position set volume can be determined based on a buffer volume of an end effector. The position set volume dimensions can be: the same throughout the position set, vary along the position set (e.g., different positions in the position set have different safety buffers), and/or otherwise related. In examples, the position set can be determined for: the entire position set, each of a set of points along the position set (e.g., sampled at uniform temporal intervals along the path, uniform spatial intervals along the path, etc.), and/or any other suitable portion of the position set.

The position set volume is preferably a swept volume, but can alternatively be formed from a set of primitives (e.g., contiguous primitives, adjacent primitives, etc.), and/or otherwise defined. In a specific example, the position set path is not the same as the CAD model or simulation. Different position set volumes can be determined for different vehicle components. In an example, a first position set volume can be determined for the entire vehicle envelope (e.g., wherein the width of the swept volume encompasses all possible positions of the vehicle components, etc.); a second position set volume can be determined for the end effector; and a third position set volume can be determined for the vehicle body. Different position set volumes can be used in different collision evaluations, and/or otherwise used. S400 can include determining multiple position set volumes, but can alternatively include determining a single position set volume.

The position set volume can be determined for a primary position set (e.g., a primary trajectory, from the primary control instructions), a fallback position set (e.g., from fallback control instructions), and/or any other position set. The primary position set can be predicted by one or more behavior models, selected from a set of candidate primary trajectories (e.g., each predicted by a different behavior model; selected based on a confidence score, relevancy to the task, etc.), and/or otherwise determined. The primary position set is preferably for the next planning timestep, but can alternatively be a primary position set for a future planning timestep, current planning timestep, prior planning timestep, and/or any other timestep. In an example, the primary position set from a prior planning timestep can be selected when the primary position set for a current planning timestep exhibits a collision and the prior primary position set does not.

In variants, determining a primary trajectory S410 functions to determine a primary trajectory that achieves the primary goal. The primary goal is preferably a construction goal (e.g., a target environment configuration; a semantic goal, such as "dig a hole"; etc.), but can be any other suitable goal. S410 is preferably performed on the main compute (e.g., main computing system), but can alternatively be performed on the secondary compute and/or any other suitable compute.

S410 is preferably performed using a main planner (e.g., example shown in FIG. 14), but can alternatively be performed using any other component. The main planner is preferably an open-loop planner, but can alternatively be a closed-loop planner. The main planner is preferably a learning-based planner (e.g., that use machine learning based techniques, etc.), but can additionally or alternatively be a classical planner (e.g., uses symbolic logic, search algorithms, etc.), probabilistic planner (e.g., that use probabilistic models), hierarchical planners, reactive planner (e.g., that generate actions based on current sensor outputs), model-based planner (e.g., that rolls out future states using a dynamic model, based on constraints and by minimizing a cost function, etc.), hybrid planner, and/or any other planner. In examples, planners that can be used include: machine learning-based planners (e.g., transformers, GNNs, RNN, etc.); model predictive control (MPC), A*, D*, and/or other planners. In an example, the main planner can be a ML-based planner that can be trained to predict a trajectory given a primary goal, a set of constraints, and/or the current system state, ambient environment state (e.g., determined from sensor measurements), historical action sequences, and/or other inputs. The main planner can output: a primary trajectory (e.g., sequence of waypoints, continuous curve in space, time-parametrized path, a task sequence or symbolic plan, etc.), control instructions (e.g., actuator instructions), expected state values (e.g., joint angles, end-effector positions, velocity profiles), kinematic constraints (e.g., joint limits, torque bounds, etc.), system parameters (e.g., gains, thresholds, timing variables, etc.), and/or any other outputs. The main planner can alternatively output: a confidence score, an operation corridor (e.g., range of permitted deviation from the trajectory), and/or any other output.

S410 is preferably determined based on the environmental state, more preferably on the environmental state sampled by the primary sensors, but can additionally or alternatively be determined based on the environmental state sampled by the secondary sensors, the vehicle state (e.g., predicted from the primary and/or secondary sensors; sampled by the vehicle sensors, etc.), the vehicle instability, and/or be determined based on other information.

However, determining a primary trajectory S410 may be otherwise performed.

In variants, the method can optionally include determining a fallback position set S430. The fallback position set (fallback trajectory) can be computed by a fallback control module (e.g., using a set of equations, classical methods, etc.), predicted by one or more fallback control module (e.g., using a neural network), selected from a set of candidate fallback trajectories (e.g., each predicted by a different fallback control module; selected based on a confidence score, relevancy to the task, etc.), and/or otherwise determined. The fallback position set is preferably determined based on the vehicle kinematics, the world representation, and/or the set of buffer volumes (e.g., inherently collision-free), but can alternatively be determined based on other information. For example, the fallback position set can be computed through volumes that are unoccupied by the set of buffer volumes (e.g., of the non-actuator objects).

In an example, the fallback position set can be determined by: optionally inflating the buffer volumes (e.g., object buffer volumes, terrain buffer volumes, unstable terrain constraints, etc.; e.g., by localization uncertainty, control latency, maximum stopping distance, tracking error, etc.); defining a stopping envelope (e.g., the set of volumes reachable by the ego vehicle component under maximum deceleration); checking for intersections between the stopping envelope and the buffer volumes (e.g., using distance-to-obstacle checks, convex polytope intersection, swept-volume collision checking, etc.); generating a set of monotonic deceleration profile based on the non-intersecting volumes in the stopping envelope (e.g., with bounded jerk, acceleration, etc.; using trapezoidal deceleration, S-curve braking profile, etc.; for each of a set of timesteps, for a swept volume, etc.); and selecting a monotonic deceleration profile based on shortest stopping distance, lowest terrain risk, lowest clearance margin, and/or other criteria. The fallback position set can be non-interruptible (e.g., expect for a safer fallback) and/or be interruptible.

In variants where the fallback position set is computed in a manner that is not inherently collision-free, the fallback position set used for the next planning timestep can be recomputed, be a fallback position set from a prior planning timestep (e.g., retrieved from memory onboard the main compute or safety compute), and/or be any other fallback position set. In an example, the fallback position set from a prior planning timestep can be selected when the fallback position set for a current planning timestep exhibits a collision and the prior fallback position set does not.

In an example, S400 can include determining a set of end effector position volumes from the end effector position set (e.g., by sweeping the end effector volume along the position set) and a vehicle position set volume from the drive actuator position set (e.g., by sweeping the entire vehicle's volume or the vehicle cab volume along the drive position set).

In variants, determining a fallback trajectory S430 functions to determine a dynamically-stable fallback trajectory that achieves the safety goal. The safety goal for S430 can be: stopping within a predetermined timeframe (e.g., within 10-15 seconds, within a timeframe computed based on the current vehicle kinematics, etc.); ensuring the kinematics (e.g., velocity, acceleration, jerk, etc.) remains within a predetermined range (e.g., below a predetermined threshold); ensuring that the vehicle dynamics (e.g., roll, yaw, etc.) remain within a threshold range; avoiding a detected obstacle in the environment (e.g., user, terrain, another vehicle, etc.); mitigating an identified risk; and/or any other safety goal. The type and/or parameter values for the safety goal can be: dynamically determined (e.g., based on the current vehicle state, the ambient environment, etc.), manually determined, selected from a predetermined list (e.g., based on the primary goal, etc.), and/or otherwise determined. S430 is preferably performed on the main compute (e.g., main computing system), but can alternatively be performed on the secondary compute (e.g., safety computing system) and/or any other suitable compute.

S430 is preferably performed in parallel with primary trajectory determination, but can alternatively be performed at a different frequency, asynchronously, and/or with any other relative timing.

S430 is preferably performed using a safety planner (e.g., fallback planner; example shown in FIG. 14), but can alternatively be performed using any other component. The safety planner can be used, but alternatively any other component can be used. The safety planner is preferably deterministic, but can alternatively be stochastic. The safety planner preferably performs open-loop planning, but can additionally or alternatively perform closed-loop planning. The safety planner is preferably a classical planner, but can additionally or alternatively be a learning-based planner, model-based planner, and/or any other planner. In examples, planners that can be used include: A*, D*, graph-based planner, model-based planner (e.g., MPC), and/or any other planners. In examples, fallback trajectory generation using a classical planner can ensure that the output trajectory is explainable, deterministic, and/or certifiably safe.

The safety planner can output a safety output and/or any other output based on the safety goal and the set of inputs. The safety output can include: a fallback trajectory (e.g., sequence of waypoints, continuous curve in space, time-parametrized path, a task sequence or symbolic plan, etc.), but can additionally or alternatively output: control instructions (e.g., actuator instructions), expected state values (e.g., joint angles, end-effector positions, velocity profiles), kinematic constraints (e.g., joint limits, torque bounds, etc.), system parameters (e.g., gains, thresholds, timing variables, etc.), and/or any other safety-related output. The fallback trajectory can differ from the primary trajectory in: goal (e.g., goal to stop within a predetermined timeframe vs. goal to achieve a target environment topography); trajectory resolution (e.g., the fallback trajectory can have higher-resolution waypoints or tasks than the primary trajectory); and/or any other characteristic. The fallback trajectory is preferably dynamically stable throughout the entire fallback trajectory, but can additionally or alternatively be unstable for a subset of the trajectory. The fallback trajectory can: halt the vehicle or component thereof (e.g., within a predetermined timeframe); avoid an obstacle in the environment (e.g., a human, terrain, another vehicle, etc.); and/or achieve any other safety goal. Can alternatively output: a confidence score, an operation corridor (e.g., range of permitted deviation from the trajectory), and/or any other output.

S430 is preferably determined based on the environmental state (e.g., sampled by the primary sensors and/or the secondary sensors) and the current vehicle state (e.g., current measurements sampled by the vehicle sensors, current state estimated from the primary or secondary measurements, etc.), but can alternatively be determined based on the vehicle instability and/or other information.

However, determining a fallback trajectory S430 may be otherwise performed.

Determining the position set volumes S400 can optionally include selecting a trajectory S450, which functions to determine which trajectory to use for physical component control. S450 is preferably performed by the controller (e.g., wherein the controller received both the primary trajectory and the fallback trajectory), but can alternatively be performed by a filter, an upstream component, and/or any other component. S450 is preferably performed on the secondary compute, but can alternatively be performed on the main compute and/or any other suitable compute. S450 is preferably selected based on the system state, more preferably system errors (e.g., whether an error has occurred, the severity of the error, the risk of the error, etc.), but can additionally or alternatively be selected based on: trajectory parameters (e.g., whether the trajectory crosses a safety boundary, trajectory confidence score, etc.), and/or other considerations. S450 preferably includes selecting the primary trajectory unless an error or fault is detected (e.g., the instability exceeds a threshold, a critical component error is issued, a safety boundary is violated, etc.), at which point the system switches to the fallback trajectory, but the trajectories can be alternatively otherwise selected.

The system errors that can cause fallback trajectory selection can include: trajectory violations (e.g., deviating from the trajectory beyond a threshold etc.), sensor failures (e.g., main camera offline), safety failures (e.g., the trajectory entering or expected to enter an obstacle's safety region), controller failures (e.g., confidence score falling below a threshold, failure to generate a trajectory or output, issuing an error, etc.), component errors (e.g., the end effector exceeding rated limits, issuing an error, etc.), computation errors, dynamics errors (e.g., vehicle instability, slippage, etc.), and/or any other system errors.

However, selecting a trajectory S450 may be otherwise performed.

However, the determining position set volumes based on a set of control instructions S400 may be otherwise configured.

Evaluating collisions between the position set volume and the set of buffer volumes S500 functions to evaluate the safety of the trajectories. S500 can be performed: every planning timestep, multiple times for each planning timestep (e.g., throughout position set execution), and/or at any other frequency. S500 can be performed by the control system, is more preferably performed by the collision detection module in the collision mitigation braking (CMB) system, but can alternatively be performed by the behavior model, or by any other suitable system. S500 is preferably performed by the main compute, but can alternatively be performed by the safety compute or any other suitable processor. In an example, determining a collision can be performed by the main compute, and the primary position set can be sent to the certified compute in response to a determination of no collision. S500 preferably includes determining whether a position set volume intersects a buffer volume, but can additionally and/or alternatively be otherwise determined.

The position set volume-buffer volume intersection evaluation (collision evaluation) can be determined for: the entire predicted position set (e.g., for the next planning timestep, for multiple planning timesteps into the future, for the next N seconds (e.g., the next 10 seconds, the next 30 seconds, etc.), for a set of predetermined time windows (e.g., for 0-1s out, for 1-2s out, etc.)), and/or any other collision evaluation time horizon. In an example, this can enable the CMB system to identify that a collision at a location presents a risk at a specific time window, but does not provide a risk outside of the time window. The collision evaluation time horizon is preferably predetermined, but can alternatively dynamically vary with the vehicle state (e.g., intersections further into the future are evaluated when the vehicle speed or acceleration increases). The collision evaluation is preferably performed as a set of checks (e.g., binary checks on whether a position volume, from the position set volumes, intersects a buffer volume, whether a position volume from the position set volume intersects a buffer volume), wherein the set of checks can be performed in parallel or in series (e.g., from the closest volumes first). Alternatively, the collision evaluation can be performed using ray casting methods (e.g., projecting rays along the position set and checking for collisions with object geometry), swept volume techniques, bounding volume techniques, configuration-space methods, distance-field-based methods, time to collision methods, occupancy-grid based methods, mesh-mesh intersection methods, contact-constraint methods, and/or any other methods.

Different collision evaluation instances can be performed for different trajectories, optionally using the respective buffer volume set. The position sets can be: drive trajectories, construction actuator trajectories, body trajectories, current end effector positions, current drive actuator positions, current vehicle body positions, and/or any other trajectories or position sets. In a first example, the drive actuator position set volume (e.g., vehicle position set volume) can be compared against the first set of buffer volumes for the set of objects (e.g., external objects, terrain, etc.), while the end effector position set volume can be compared against a second set of buffer volumes for the same or overlapping set of objects (e.g., external objects, terrain, ego components, etc.). In a second example, both the end effector position set volume and the fallback position set volume can be compared against the set of object buffer volumes.

However, evaluating collisions between the position set volume and the set of buffer volumes S500 may be otherwise configured.

Determining a set of final control instructions based on the collision evaluation S600 functions to control the vehicle (e.g., end effectors, drive actuators, etc.) using the final control instructions (e.g., safe control instructions). S600 is preferably be performed on the main compute, but can alternatively be performed on the safety compute and/or on any other processing system. S600 can be performed by CMB system, more preferably by the decision module of the CMB system, but can alternatively be performed by the motion controller and/or by any other module. S600 can be performed for every control timestep, multiple times for each control timestep, and/or at any other time. Each planning timestep can include multiple control timesteps, include a single control timestep, and/or be otherwise related to the control timesteps. S600 can be performed at intervals of 10 to 100 milliseconds, less than 10 milliseconds, more than 100 milliseconds, and/or at other intervals; can be performed at dynamically changing intervals; can be performed at longer intervals during long position displacements in sparse environments, and shorter intervals in crowded and/or high-risk environments; and/or can be performed at any other suitable frequency. S600 is preferably based on the selected trajectory, vehicle state, primary measurements, secondary measurements, and/or any other information. S600 is preferably performed on the secondary compute, but can alternatively be performed on the main compute and/or any other suitable compute.

S600 can include sending control instructions from the main compute to the safety compute, from the main compute to the memory, and/or otherwise routing the control instructions. S600 preferably includes sending control instructions from the collision mitigation braking system to the motion control module, but can alternatively include sending component instructions (e.g., actuator commands) from the motion control module to a component, sending control instructions from the behavior model to the CMB, sending control instructions from the behavior model to the motion controller, and/or other processes. The final control instructions can be explicitly specified (e.g., downstream processes are explicitly instructed to implement a specific control instruction type) or implicitly specified (e.g., downstream processes are only provided control instructions that should be executed, downstream processes are hardcoded to preferentially execute a control instruction type when provided, etc.). The final control instructions are preferably provided to the motion control module, wherein the motion control module generates component instructions (e.g., actuator instructions, actuator commands, etc.) for the vehicle based on the final control instructions, but can alternatively be provided to any other endpoint.

In a first variant, S600 can include: sending the primary control instructions to a motion control module when no collision is detected; and sending a fallback control instruction (e.g., emergency stop, deceleration position set, etc.) to the motion control module in lieu of the primary control instructions when a collision is detected. The motion controller then generates the actuator instructions (e.g., actuator commands) based on the received control instructions.

In a second variant, S600 can include: sending the primary control instructions at all timesteps; sending no signal when no collision is detected, sending a fallback control instruction when a collision is detected wherein the motion control module preferentially implements the fallback control instruction when available (e.g., generates the actuator instructions based on the preferred control instructions).

In a third variant, S600 can include: sending the fallback control instructions to the safety compute at all timesteps, and sending the primary control instructions to the safety compute when no collision is detected; wherein the motion control module in the safety compute preferentially implements (e.g., generates the actuator instructions based on the control instructions) the primary control instructions when available or when explicitly specified by the decision module, and implements the fallback control instructions otherwise. In this variant, the fallback control instructions (e.g., deceleration position set, emergency stop, etc.) can optionally be stored (e.g., cached) at the processor executing the motion controller, wherein a prior fallback control instruction can be implemented when a fault is detected (e.g., a system fault, sensor fault, main compute fault, etc.). In an example, storing the fallback control instructions can include replacing a previous fallback control instruction with an updated fallback control instruction, and/or otherwise storing the fallback control instructions.

In a fourth variant, S600 can be performed using the controller, and/or using any other suitable component and/or at any other time. The controller is preferably a closed-loop controller, but can alternatively be an open-loop controller. In examples of the first variant, types of controllers that can be used include: MPC controller, PID controller, LQR/LQG controller, feedback linearization, adaptive controller, sliding mode control (SMC), and/or any other controllers.

In a fifth variant, control instructions associated with the selected trajectory are passed through. In this variant, the control instructions can be generated by the main planner (e.g., when generating the primary trajectory), and/or by any other component.

However, determining a set of final control instructions based on the collision evaluation S600 may be otherwise configured.

5. Specific Examples

Specific example 1. A method for off-highway vehicle control, comprising: at non-safety-qualified compute: generating a set of primary control instructions comprising a trajectory for an end effector of the vehicle; generating a set of buffer volumes based on a world representation of an environment surrounding the vehicle; determining whether the trajectory collides with the set of buffer volumes using a geometric intersection check; and sending a set of final control instructions to a safety-qualified compute, wherein the set of final control instructions comprise the set of primary control instructions when no collision is detected, and do not comprise the primary control instructions when a collision is detected; and at the safety-qualified compute: generating a set of actuator commands based on the set of final control instructions, and controlling vehicle actuators based on the set of actuator commands.

Specific example 2. The method of specific example 1, further comprising: at the non-safety-qualified compute, generating a set of fallback control instructions based on the world representation, wherein the set of fallback control instructions comprise a maximum deceleration trajectory for the end effector, wherein the set of final control instructions comprise the set of fallback control instructions; and wherein the safety-qualified compute generates the set of actuator commands based on the set of fallback control instructions when the primary control instructions are unavailable.

Specific example 3. The method of specific example 2, wherein the set of fallback control instructions results in an inertially-stable vehicle stop.

Specific example 4. The method of specific example 2, wherein the set of fallback control instructions comprises a vehicle stop position that overlaps an original position of the vehicle from a prior control timestep.

Specific example 5. The method of specific example 1, wherein the safety-qualified compute stores the set of fallback control instructions and generates the set of actuator commands based on the set of fallback control instructions when a system fault is detected.

Specific example 6. The method of specific example 1, wherein the set of buffer volumes comprise a set of geometric primitives located at detected object positions within the world representation, wherein dimensions of each geometric primitive are determined based on a predicted operational context for the respective detected object.

Specific example 7. The method of specific example 2, wherein the set of fallback control instructions and the set of primary control instructions are generated for a common timestep.

Specific example 8. The method of specific example 1, wherein the set of buffer volumes comprise a set of ego buffer volumes surrounding a body of the vehicle, wherein determining whether the trajectory collides with the set of buffer volumes comprises determining whether the trajectory collides with the set of ego buffer volumes.

Specific example 9. The method of specific example 1, wherein the set of behavior models comprise neural networks and the set of motion controllers are deterministic.

Specific example 10. The method of specific example 1, wherein determining whether the trajectory collides with the set of buffer volumes comprises: determining a trajectory volume based on the trajectory, and evaluating in closed form whether the trajectory volume intersects the set of buffer volumes.

Specific example 11. A method comprising: generating a trajectory for an end effector of an ego vehicle; generating a set of buffer volumes based on a 3D model of the ego vehicle, wherein the set of buffer volumes comprises: a first buffer volume associated with a body of the ego vehicle, wherein the body of the ego vehicle comprises a cabin; and a second buffer volume associated with the end effector of the ego vehicle; determining a trajectory volume for the end effector based on the trajectory and the second buffer volume; evaluating whether the trajectory volume intersects the first buffer volume; generating a set of actuator commands based on the trajectory when the trajectory volume does not intersect the first buffer volume; and controlling the ego vehicle based on the set of actuator commands.

Specific example 12. The method of specific example 11, wherein the end effector wherein the end effector comprises an articulated component that is kinematically downstream of a controllable joint.

Specific example 13. The method of specific example 11, further comprising generating a world representation of an environment surrounding the ego vehicle, and wherein generating the set of buffer volumes further comprises generating a set of object buffer volumes for detected objects within the world representation.

Specific example 14. The method of specific example 13, wherein: a behavior model generates the set of buffer volumes for the end effector; a perception model generates the world representation; and the perception model and the behavioral model share an embedding layer.

Specific example 15. The method of specific example 11, wherein the set of buffer volumes comprise primitive volumetric geometries, wherein evaluating whether the trajectory volume intersects the first buffer volume comprises a closed-form geometric intersection check.

Specific example 16. The method of specific example 11, wherein the set of buffer volumes is generated based on a target operation of the end effector.

Specific example 17. The method of specific example 11, wherein: the trajectory is predicted by a set of behavior models; the set of actuator commands is generated by a set of motion control modules; and the set of behavior models are updated without recertification.

Specific example 18. The method of specific example 17, wherein the set of behavior models are executed on a non-safety-qualified compute, and the set of motion controllers are executed on a set of safety-qualified compute.

Specific example 19. The method of specific example 17, wherein the set of motion control modules deterministically generate the set of actuator commands.

Specific example 20. The method of specific example 11, wherein the set of buffer volumes comprises a nested set of buffer volumes, wherein different buffer volumes in the set of buffer volumes are associated with different permissible sets of actions.

Specific example 21. The method of specific example 11, further comprising generating the set of actuator commands based on a set of fallback control instructions when the trajectory volume intersects the first buffer volume, wherein the set of fallback control instructions and the set of buffer volumes are determined based on a mass of contents manipulated by the end effector.

Specific example 22. A system configured to perform the methods of any of specific examples 1-21.

Specific example 23. A system comprising: a vehicle with a set of actuators and a set of sensors; a control system comprising: a perception module configured to detect objects in the ambient environment from sensor measurements sampled by the set of sensors, a set of behavior models configured to determine (e.g., predict) a set of control instructions based on the sensor measurements, a collision mitigation system configured to: determine object buffer volumes and ego buffer volumes around the detected objects and ego vehicle components, respectively (e.g., wherein the ego vehicle component poses in a global reference frame are determined from onboard sensor measurements), determine collisions between the object buffer volumes and ego buffer volumes at each of a set of ego vehicle positions implemented by the set of control instructions, determine a set of fallback control instructions (e.g., inertially stable and collision-free), selectively pass the control instructions when no collisions are detected between the object buffer volumes and ego buffer volumes, and otherwise pass the fallback control instructions; and a set of motion controllers configured to convert received control instructions into actuator commands, wherein the set of actuators are controlled based on the actuator commands.

Specific example 24. The system of specific example 23, further comprising non-safety-qualified compute executing the perception module, the set of behavior models, and the collision mitigation system are executed on; and safety-qualified compute executing the set of motion controllers.

All references cited herein are incorporated by reference in their entirety, except to the extent that the incorporated material is inconsistent with the express disclosure herein, in which case the language in this disclosure controls.

As used herein, "substantially" or other words of approximation can be within a predetermined error threshold or tolerance of a metric, component, or other reference, and/or be otherwise interpreted.

Optional elements, which can be included in some variants but not others, are indicated in broken line in the figures. However, unbroken lines in the figures should not be interpreted to indicate that the depicted elements are essential, nor to indicate that the depicted elements may not be omitted from variants of the invention.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method for off-highway vehicle control, comprising:
That non-safety-qualified compute:
generating a set of primary control instructions comprising a trajectory for an end effector of the vehicle;
generating a set of buffer volumes based on a world representation of an environment surrounding the vehicle;
determining whether the trajectory collides with the set of buffer volumes using a geometric intersection check; and
sending a set of final control instructions to a safety-qualified compute, wherein the set of final control instructions comprise the set of primary control instructions when no collision is detected, and do not comprise the primary control instructions when a collision is detected; and
at the safety-qualified compute:
generating a set of actuator commands based on the set of final control instructions; and
controlling vehicle actuators based on the set of actuator commands.

2. The method of claim 1, further comprising:
wherein the safety-qualified compute generates the set of actuator commands based on the set of fallback control instructions when the primary control instructions are unavailable.

3. The method of claim 2, wherein the set of fallback control instructions results in an inertially-stable vehicle stop.

4. The method of claim 2, wherein the set of fallback control instructions comprises a vehicle stop position that overlaps an original position of the vehicle from a prior control timestep.

5. The method of claim 1, wherein the safety-qualified compute stores the set of fallback control instructions and generates the set of actuator commands based on the set of fallback control instructions when a system fault is detected.

6. The method of claim 1, wherein the set of buffer volumes comprise a set of geometric primitives located at detected object positions within the world representation, wherein dimensions of each geometric primitive are determined based on a predicted operational context for the respective detected object.

7. The method of claim 2, wherein the set of fallback control instructions and the set of primary control instructions are generated for a common timestep.

8. The method of claim 1, wherein the set of buffer volumes comprise a set of ego buffer volumes surrounding a body of the vehicle, wherein determining whether the trajectory collides with the set of buffer volumes comprises determining whether the trajectory collides with the set of ego buffer volumes.

9. The method of claim 1, wherein the set of behavior models comprise neural networks and the set of motion controllers are deterministic.

10. A method comprising:
generating a trajectory for an end effector of an ego vehicle;
generating a set of buffer volumes based on a 3D model of the ego vehicle, wherein the set of buffer volumes comprises:
a first buffer volume associated with a body of the ego vehicle, wherein the body of the ego vehicle comprises a cabin; and
a second buffer volume associated with the end effector of the ego vehicle;
determining a trajectory volume for the end effector based on the trajectory and the second buffer volume;
generating a set of actuator commands based on the trajectory when the trajectory volume does not intersect the first buffer volume; and
controlling the ego vehicle based on the set of actuator commands.

11. The method of claim 10, wherein the end effector wherein the end effector comprises an articulated component that is kinematically downstream of a controllable joint.

12. The method of claim 10, further comprising generating a world representation of an environment surrounding the ego vehicle, and wherein generating the set of buffer volumes further comprises generating a set of object buffer volumes for detected objects within the world representation.

13. The method of claim 12, wherein:
a behavior model generates the set of buffer volumes for the end effector;
a perception model generates the world representation; and
the perception model and the behavioral model share an embedding layer.

14. The method of claim 10, wherein the set of buffer volumes comprise primitive volumetric geometries, wherein evaluating whether the trajectory volume intersects the first buffer volume comprises a closed-form geometric intersection check.

15. The method of claim 10, wherein the set of buffer volumes is generated based on a target operation of the end effector.

16. The method of claim 10, wherein:
the trajectory is predicted by a set of behavior models;
the set of actuator commands is generated by a set of motion control modules; and
the set of behavior models are updated without recertification.

17. The method of claim 16, wherein the set of behavior models are executed on a non-safety-qualified compute, and the set of motion controllers are executed on a set of safety-qualified compute.

18. The method of claim 16, wherein the set of motion control modules deterministically generate the set of actuator commands.

19. The method of claim 10, wherein the set of buffer volumes comprises a nested set of buffer volumes, wherein different buffer volumes in the set of buffer volumes are associated with different permissible sets of actions.

20. The method of claim 10, further comprising generating the set of actuator commands based on a set of fallback control instructions when the trajectory volume intersects the first buffer volume, wherein the set of fallback control instructions and the set of buffer volumes are determined based on a mass of contents manipulated by the end effector.
